(19) United States
(12) Patent Application Publication
(10) Pub. No.: US 2026/0307995 A1
(43) Pub. Date: Oct. 8, 2026

(54) METHODS OF PREPARING HARD CARBON MATERIAL AND ENERGY STORAGE DEVICE AND METHOD OF ENHANCING PLATEAU CAPACITY

(71) Applicant: National Tsing Hua University, Hsinchu City (TW)

(72) Inventors: Chi-Chang HU, Hsinchu City (TW); Liang-Chieh Tseng, Hsinchu City (TW); Yun Lin, Hsinchu City (TW); Wen-Yang Jao, Hsinchu City (TW); Yu-Chun Chen, Hsinchu City (TW)

(21) Appl. No.: 19/279,994

(22) Filed: Jul. 24, 2025

(30) Foreign Application Priority Data
Mar. 26, 2025 (TW) 114111488

(51) Int. Cl. C01B 32/05; C08G 8/20; H01M 4/04; H01M 4/587

(52) U.S. Cl. CPC C01B 32/05; C08G 8/20; H01M 4/0404; H01M 4/0471; H01M 4/587; C01P 2002/72; C01P 2002/82; C01P 2002/85; C01P 2004/04; C01P 2006/14; C01P 2006/40

(57) ABSTRACT

Provided is a method of preparing a hard carbon material having closed pores. By employing Novolak oligomers, the cross-linking density of the phenolic-formaldehyde resins can be controlled within a range from 0.5 to 0.999 through a recondensation reaction. Based on the cross-linking density, an appropriate carbonization temperature is set for the thermal treatment, generating multiple closed pores in the hard carbon material and controlling the closed pore volume within a range from 0.1 cm³/g to 0.4 cm³/g. As a result, a hard carbon material with a desired closed pore structure and an enhanced closed pore volume can be obtained, thereby enhancing both the plateau capacity and the overall capacity when applied to the lithium-ion batteries.

### CROSS-REFERENCE TO RELATED APPLICATION

Pursuant to 35 U.S.C. § 119(a), this application claims the benefit of the priority to Taiwan Patent Application No. 114111488 filed Mar. 26, 2025. The content of the prior application is incorporated herein by its entirety.

### BACKGROUND OF THE INVENTION

### 1. Field of the Invention

The instant disclosure relates to a hard carbon material and an energy storage device comprising the same, especially to a method of preparing a hard carbon material having closed pores, a method of preparing an energy storage device comprising the hard carbon material, and a method of enhancing the plateau capacity of the energy storage device comprising the same.

### 2. Description of the Prior Arts

Lithium-ion batteries (LIBs), due to their high energy density, high power density, and acceptable charge/discharge cycle characteristics, have been widely applied in various electronic devices. Sodium-ion batteries (SIBs), with advantages of high safety, good low-temperature performance, low cost, and the abundance of sodium resources, become next-generation batteries and have attracted significant attention in recent years.

As the active material of negative electrodes, also called anode active materials, for both lithium-ion batteries and sodium-ion batteries, carbon-based negative electrode materials can be classified into graphite with high crystallinity (including natural graphite and artificial graphite) and amorphous carbon materials. Amorphous carbon materials can further be classified into hard carbon (HC) and soft carbon (SC). Compared to the highly crystalline graphite material, hard carbon, a non-graphitizable material, features a turbostratic, disordered structure that creates defects and pores, and possesses a larger interlayer spacing than graphite. In the applications of energy storage devices, hard carbon materials can achieve a higher theoretical Li-ion/Na-ion storage capacity than graphite.

However, lithium-ion batteries using hard carbon as the active materials of negative electrodes typically exhibit sloping galvanostatic charge/discharge (GCD) curves governed by adsorption reactions. This makes it difficult to form a low-potential plateau region on the GCD curve when using the traditional hard carbon, thus only a relatively lower reversible capacity can be provided in comparing with graphite. To enhance the reversible capacity, attempts have been made to dope with heteroatoms such as nitrogen, phosphorus, or sulfur in the past, aiming to introduce additional reaction sites into the carbon structure to address the aforementioned issue. Nevertheless, such doping methods tend to deteriorate other charge/discharge performance. Therefore, there is still a need to develop alternative approaches to optimize hard carbon materials without the need for additional heteroatom doping, and to create a desired plateau region on the GCD curve when applied in lithium-ion batteries.

### SUMMARY OF THE INVENTION

In view of the drawbacks in the prior arts, an objective of the instant disclosure is to modify the preparation method for hard carbon materials, creating a low-potential plateau region on the GCD curve without the need for additional heteroatom doping, thereby enhancing the overall capacity of an energy storage device.

To achieve the foresaid objective, the instant disclosure provides a method of preparing a hard carbon material having closed pores, comprising steps of:
reacting a phenolic compound with an aldehyde compound in the presence of an acid catalyst to prepare a phenolic-formaldehyde oligomer;
subjecting the phenolic-formaldehyde oligomer, a cross-linking reagent, and a protection reagent to a recondensation reaction, so as to obtain a phenolic-formaldehyde resin, wherein the phenolic-formaldehyde resin has a cross-linking density ranging from 0.5 to 0.999, inclusive; and
thermally treating the phenolic-formaldehyde resin at a carbonization temperature ranging from 700° C. to 1500° C., inclusive, to obtain a hard carbon material, wherein the hard carbon material comprises multiple closed pores, and a total volume of the closed pores of the hard carbon material ranges from 0.1 cubic centimeters per gram (cm³/g) to 0.4 cm³/g, inclusive.

Via the acid-catalyzed reaction, the phenolic-formaldehyde oligomer prepared from a reaction between the phenolic compound and the aldehyde compound can be Novolak-typed phenolic-formaldehyde oligomer. By employing the Novolak-typed phenolic-formaldehyde oligomer, it is beneficial to control the recondensation reaction and ensure the phenolic-formaldehyde resin has a cross-linking density within the expected range. In addition, by adjusting the carbonization temperature according to the cross-linking density of the phenolic-formaldehyde resin, the carbonization reaction can be promoted more effectively, thereby facilitating the formation of the desired closed pore structure and increasing the closed pore volume in the resulting hard carbon material. Accordingly, the preparation method of the instant disclosure can successfully ensure the formation of the closed pore structure in the hard carbon material. Such a hard carbon material having closed pores can exhibit favorable charge/discharge performance when applied in lithium-ion batteries, leading to an enhanced capacity in the low-potential plateau region and an enhanced overall capacity as well.

In addition, the method also facilitates the formation of a low-potential plateau region on the GCD curve without compromising the initial charge/discharge efficiency, thereby improving both the initial coulombic efficiency (ICE) and the reversible capacity.

Via the acid-catalyzed reaction, the phenolic-formaldehyde resin prepared from the foresaid oligomer may be Novolak-typed phenolic-formaldehyde resin. Said acid-catalyzed approach is beneficial to control the bonding behavior during the preparation of the phenolic-formaldehyde oligomers, and thus the ortho ratio of the phenolic-formaldehyde oligomers can be regulated.

Optionally, in the preparation of the phenolic-formaldehyde oligomer by using an acid catalyst, a temperature of reaction between the phenolic compound and the aldehyde compound may range from 80° C. to 120° C., inclusive. Also, the reaction temperature may be 80° C., 85° C., 90° C., 95° C., 100%, 105° C., 110° C., 115° C., 120° C., or within the ranges between any two of the above values, inclusive.

Optionally, a molar ratio of the aldehyde compound relative to the phenolic compound may range from 0.6:1 to 0.9:1, inclusive. The molar ratio may be 0.60:1, 0.65:1, 0.70:1, 0.75:1, 0.80:1, 0.85:1, 0.90:1, or within the ranges between any two of the above values, inclusive. In one embodiment, the phenolic compound is phenol and the aldehyde compound is formaldehyde, and a molar ratio of formaldehyde relative to phenol, represented by a F/P ratio, may be from 0.6:1 to 0.9:1, or within the ranges between any two of the above values, inclusive.

In the preparation method, the thermal treatment may be performed under an inert atmosphere to obtain the desired hard carbon material. The inert atmosphere applicable to the instant disclosure comprises a nitrogen atmosphere or an argon atmosphere, but is not limited thereto.

Optionally, the phenolic-formaldehyde oligomer can be reacted with a cross-linking reagent and a protection reagent to prepare the phenolic-formaldehyde resin. Specifically, the method comprises steps of:
mixing the phenolic-formaldehyde oligomer, the cross-linking reagent, and the protection reagent in a solvent to obtain a mixture;
heating the mixture at a temperature between 100° C. and 180° C., inclusive, by microwave to obtain a suspension solution containing the phenolic-formaldehyde resin; and
filtering and drying the suspension solution, so as to collect the phenolic-formaldehyde resin from the suspension solution.

In the preparation method, the phenolic-formaldehyde oligomer is reacted with the cross-linking reagent and the protection reagent via the microwave-assisted suspension polymerization, so as to ensure a uniform cross-linking and curing reaction. The power of microwave may be set between 50 watts and 200 watts, inclusive, but is not limited thereto.

In the preparation method, the filtration and drying manners for the suspension solution are not particularly limited. The filtration applicable to the instant disclosure may be, for example, suction filtration. The suspension solution may be dried by, for example, air drying, vacuum drying, or oven drying at a temperature from 60° C. to 90° C., inclusive, but is not limited thereto. In the preparation method, an amount of the cross-linking reagent ranges from parts by weight (pbw) to 100 pbw, inclusive, based on 100 pbw of the phenolic-formaldehyde oligomer. The cross-linking reagent may be hexamethylenetetramine, formaldehyde acetal, furfural, furfural alcohol, or trimethylol phosphine oxide. Optionally, the amount of the cross-linking reagent may be 5 pbw, 10 pbw, 15 pbw, 20 pbw, 30 pbw, 40 pbw, 50 pbw, 60 pbw, 70 pbw, 80 pbw, 90 pbw, 100 pbw, or within the ranges between any two of the above values, inclusive.

In the preparation method, an amount of the protection reagent ranges from 1 pbw to 10 pbw, inclusive, based on 100 pbw of the phenolic-formaldehyde oligomer. The protection reagent may be polyvinyl alcohol, methyl cellulose, or polyoxyethylene polyoxypropylene. Optionally, the amount of the protection reagent may be 1 pbw, 2 pbw, 3 pbw, 4 pbw, 5 pbw, 6 pbw, 7 pbw, 8 pbw, 9 pbw, 10 pbw, or within the ranges between any two of the above values, inclusive.

Optionally, an ortho ratio of the phenolic-formaldehyde oligomer may range from 50% to 100%, inclusive, or may be 50%, 55%, 60%, 65%, 70%, 75%, 80%, 85%, 90%, 95%, 96%, 97%, 98%, 99%, 100%, or within the ranges between any two of the above values, inclusive.

The ortho ratio of the phenolic-formaldehyde oligomer may be controlled as desired. The ortho ratio of the phenolic-formaldehyde resin may also be regulated by choosing the appropriate phenolic-formaldehyde oligomer and cross-linking reagent and/or tuning the amount of the cross-linking reagent. Optionally, the ortho ratio of the phenolic-formaldehyde resin may range from 10% to 50%, inclusive, or may be 10%, 15%, 20%, 25%, 30%, 35%, 40%, 45%, 50%, or within the ranges between any two of the above values, inclusive.

The closed pore volume of the hard carbon material may be maximized by setting an appropriate carbonization temperature according to the cross-linking density of the phenolic-formaldehyde resin. Optionally, the closed pore volume of the hard carbon material may be 0.10 cm³/g, 0.11 cm³/g, 0.12 cm³/g, 0.13 cm³/g, 0.14 cm³/g, 0.15 cm³/g, 0.16 cm³/g, 0.17 cm³/g, 0.18 cm³/g, 0.19 cm³/g, 0.20 cm³/g, 0.22 cm³/g, 0.24 cm³/g, 0.26 cm³/g, 0.28 cm³/g, 0.30 cm³/g, 0.32 cm³/g, 0.34 cm³/g, 0.36 cm³/g, 0.38 cm³/g, 0.40 cm³/g, or within the ranges between any two of the above values, inclusive. Preferably, the closed pore volume of the hard carbon material may be 0.18 cm³/g, 0.19 cm³/g, 0.20 cm³/g, 0.25 cm³/g, 0.30 cm³/g, 0.35 cm³/g, 0.36 cm³/g, 0.37 cm³/g, 0.38 cm³/g, or within the ranges between any two of the above values, inclusive. With increasing the closed pore volume, employing the hard carbon materials as the negative electrode active materials can effectively enhance both the plateau region capacity and the overall capacity when applied to the lithium-ion batteries.

Optionally, the cross-linking density of the phenolic-formaldehyde resin may be 0.50, 0.55, 0.60, 0.65, 0.70, 0.75, 0.80, 0.85, 0.90, 0.91, 0.92, 0.93, 0.94, 0.95, 0.96, 0.97, 0.98, 0.99, 0.995, 0.996, 0.997, 0.998, 0.999, or within the ranges between any two of the above values, inclusive.

Optionally, the carbonization temperature may be 700° C., 750° C., 800° C., 850° C., 900° C., 950° C., 1000° C., 1050° C., 1100° C., 1150° C., 1200° C., 1250° C., 1300° C., 1350° C., 1400° C., 1450° C., 1500° C., or within the ranges between any two of the above values, inclusive. With the reduced cross-linking density, the phenolic-formaldehyde resin can be carbonized at a lower carbonization temperature. Under an appropriate thermal treatment, the hard carbon material can possess the desired closed pore structure and closed pore volume, thereby improving the performance of the subsequent lithium-ion battery product.

In one embodiment, the phenolic compound is phenol, the aldehyde compound is formaldehyde, and the acid catalyst is zinc diacetate. An amount of the zinc diacetate relative to that of the phenol may range from 0.5 wt % to 10 wt %, inclusive. Optionally, the amount of the zinc diacetate relative to the phenol may be 0.5 wt %, 1 wt %, 1.5 wt %, 2 wt %, 2.5 wt %, 3 wt %, 3.5 wt %, 4 wt %, 4.5 wt %, 5 wt %, 5.5 wt %, 6 wt %, 6.5 wt %, 7 wt %, 7.5 wt %, 8 wt %, 8.5 wt %, 9 wt %, 9.5 wt %, 10 wt %, or within the ranges between any two of the above values, inclusive. By using zinc diacetate as the acid catalyst, a phenolic-formaldehyde oligomer with a highly ortho-oriented arrangement can be prepared. When the cross-linking density of the phenolic-formaldehyde resin is within a range between 0.5 and 0.9, the carbonization temperature may be set from 700° C. to 1400° C., inclusive. Or, when the cross-linking density of the phenolic-formaldehyde resin is within a range between 0.60 and 0.85, the carbonization temperature may be set from 750° C. to 1150° C., inclusive. In this embodiment, the ortho ratio of the phenolic-formaldehyde oligomer may be 70% to 100%, and the ortho ratio of the phenolic-formaldehyde resin may be 30% to 50%.

In another embodiment, the phenolic compound is phenol, the aldehyde compound is formaldehyde, and the acid catalyst is oxalic acid. An amount of the oxalic acid relative to that of the phenol ranges from 0.5 wt % to 10 wt %, inclusive. Optionally, the amount of the oxalic acid relative to the phenol may be 0.5 wt %, 1 wt %, 1.5 wt %, 2 wt %, 2.5 wt %, 3 wt %, 3.5 wt %, 4 wt %, 4.5 wt %, 5 wt %, 5.5 wt %, 6 wt %, 6.5 wt %, 7 wt %, 7.5 wt %, 8 wt %, 8.5 wt %, 9 wt %, 9.5 wt %, 10 wt %, or within the ranges between any two of the above values, inclusive. By using oxalic acid as the acid catalyst, a phenolic-formaldehyde oligomer with a random arrangement can be prepared. When the cross-linking density of the phenolic-formaldehyde resin is within a range between 0.90 and 0.999 or a range between 0.91 and 0.999, the carbonization temperature can be set within a range between 850° C. and 1450° C., inclusive. Or, when the cross-linking density of the phenolic-formaldehyde resin may be 0.95 to 0.995, the carbonization temperature may be set within a range between 850° C. and 1350° C., inclusive. In this embodiment, the ortho ratio of the phenolic-formaldehyde oligomer may range from 50% to 70%, inclusive, and the ortho ratio of the phenolic-formaldehyde resin may range from 10% to 30%, inclusive.

It is advantageous to control the monomer arrangement in the phenolic-formaldehyde oligomer by adopting an appropriate acid catalyst. The ortho ratio of the phenolic-formaldehyde oligomer can be controlled by adopting either the phenolic-formaldehyde oligomers with a highly ortho-oriented arrangement or the phenolic-formaldehyde oligomer with a random arrangement, and therefore, the ortho ratio and the cross-linking density of the condensed phenolic-formaldehyde resin can be also controlled.

In addition to the ortho ratio of the phenolic-formaldehyde oligomer, the desired cross-linking density of the condensed phenolic-formaldehyde resin can be obtained by adjusting the amount of the cross-linking reagent, the type of the cross-linking reagent, and/or the reaction temperature.

According to the foresaid method, an I_{D}/I_{G} ratio of the hard carbon material may be from 1.80 to 3.00. Optionally, the I_{D}/I_{G} ratio of the hard carbon material may be 1.80, 1.90, 2.00, 2.10, 2.20, 2.30, 2.40, 2.50, 2.60, 2.70, 2.80, 2.90, 3.00, or within the ranges between any two of the above values, inclusive.

According to the foresaid method, L_{c} of the hard carbon material may be from 0.95 nm to 1.20 nm. Optionally, L_{c} of the hard carbon material may be 0.95 nm, 0.96 nm, 0.97 nm, 0.98 nm, 0.99 nm, 1.00 nm, 1.05 nm, 1.10 nm, 1.15 nm, 1.20 nm, or within the ranges between any two of the above values, inclusive.

According to the foresaid method, Lₐ of the hard carbon material may be from 2.50 nm to 4.20 nm. Optionally, Lₐ of the hard carbon material may be 2.50 nm, 2.60 nm, 2.70 nm, 2.80 nm, 2.90 nm, 3.00 nm, 3.10 nm, 3.20 nm, 3.30 nm, 3.40 nm, 3.50 nm, 3.60 nm, 3.70 nm, 3.80 nm, 3.90 nm, 4.00 nm, 4.10 nm, 4.20 nm, or within the ranges between any two of the above values, inclusive.

The preparation method of the instant disclosure is effective to maximize the closed pore volume of the hard carbon material, and obtain the hard carbon material in the shape of, for example, microbead. Hence, the hard carbon material of the instant disclosure can be applied to various energy storage batteries.

The instant disclosure also provides a method of enhancing a plateau region capacity of an energy storage device. The method comprises utilizing the hard carbon material having closed pores as prepared by the previous method to be the negative electrode active material of the energy storage device. The hard carbon material has a closed pore volume ranging from 0.1 cm³/g to 0.4 cm³/g, inclusive. In one embodiment, the method comprises coating a negative electrode active material of the energy storage device onto a metal foil, and the negative electrode active material comprises a hard carbon material having closed pores, which is prepared by the previous method.

In addition, the instant disclosure provides a method of preparing an energy storage device, comprising steps of:
coating a negative electrode slurry onto a negative electrode current collector and then drying it to obtain a negative electrode;
coating a positive electrode slurry onto a positive electrode current collector and then drying it to obtain a positive electrode; and
placing the negative electrode, the positive electrode, and a separator film into a case, and filling an electrolyte solution into the case to prepare the energy storage device;
wherein the negative electrode slurry comprises a negative electrode active material, and the negative electrode active material comprises a hard carbon material having closed pores prepared by the previous method.

Optionally, the electrolyte solution comprises a lithium salt solution or a sodium salt solution. The lithium salt solution may be a lithium hexafluorophosphate (LiPF₆) solution or a sodium hexafluorophosphate (NaPF₆) solution. The solvent in the electrolyte solution comprises ethylene carbonate (EC), propylene carbonate (PC), dimethyl carbonate (DMC), diethyl carbonate (DEC), or ethyl methyl carbonate (EMC), but is not limited thereto.

Optionally, the positive electrode slurry comprises a positive electrode active material, such as LiFePO₄ (LFP), LiCoO₂, LiNiO₂, or LiMn₂O₄, but is not limited thereto. In another embodiment, the positive electrode active material may be, for example, NaFePO₄, NaCoO₂, NaNiO₂, NaFeO₂, NaVO₂, or NaMn₂O₄, but is not limited thereto.

Optionally, the closed pore volume of the hard carbon material may be from 0.18 cm³/g to 0.38 cm³/g. Maximizing the closed pore volume of the hard carbon material is helpful to enhance the plateau region capacity of the energy storage device, and thus enhance its overall capacity.

In accordance with the instant disclosure, the energy storage device may be a lithium-ion battery (LIB) or a sodium-ion battery (SIB).

In one embodiment, the lithium-ion battery exhibits a plateau region capacity from 40 milliampere-hours per gram (mAh/g) to 450 mAh/g, a sloping region capacity from 120 mAh/g to 400 mAh/g, and an overall capacity from 160 mAh/g to 850 mAh/g.

Optionally, the plateau region capacity of the lithium-ion battery may be 40 mAh/g, 50 mAh/g, 80 mAh/g, 100 mAh/g, 120 mAh/g, 150 mAh/g, 180 mAh/g, 200 mAh/g, 220 mAh/g, 250 mAh/g, 280 mAh/g, 300 mAh/g, 320 mAh/g, 350 mAh/g, 380 mAh/g, 400 mAh/g, 420 mAh/g, 450 mAh/g within the ranges between any two of the above values, inclusive. The overall capacity of the lithium-ion battery may be 160 mAh/g, 200 mAh/g, 250 mAh/g, 300 mAh/g, 350 mAh/g, 400 mAh/g, 450 mAh/g, 500 mAh/g, 550 mAh/g, 600 mAh/g, 650 mAh/g, 700 mAh/g, 750 mAh/g, 800 mAh/g, 850 mAh/g, or within the ranges between any two of the above values, inclusive.

Preferably, a proportion of the plateau region capacity of the lithium-ion battery relative to its overall capacity may be greater than or equal to 35%, or range from 35% to 55%, inclusive. Optionally, the proportion of the plateau region capacity relative to the overall capacity may be 35%, 40%, 45%, 50%, 55%, or within the ranges between any two of the above values, inclusive.

In another embodiment, the energy storage device is the sodium-ion battery, which exhibits a plateau region capacity from 150 mAh/g to 400 mAh/g, a sloping region capacity from 50 mAh/g to 200 mAh/g, and an overall capacity from 200 mAh/g to 600 mAh/g. Optionally, the plateau region capacity of the sodium-ion battery may be 150 mAh/g, 180 mAh/g, 200 mAh/g, 220 mAh/g, 250 mAh/g, 280 mAh/g, 300 mAh/g, 320 mAh/g, 350 mAh/g, 380 mAh/g, 400 mAh/g, or within the ranges between any two of the above values, inclusive. The overall capacity of the sodium-ion battery may be 200 mAh/g, 250 mAh/g, 300 mAh/g, 330 mAh/g, 350 mAh/g, 400 mAh/g, 450 mAh/g, 500 mAh/g, 550 mAh/g, 600 mAh/g, or within the ranges between any two of the above values, inclusive.

Preferably, a proportion of the plateau capacity in the sodium-ion battery may be greater than or equal to 50% of the overall capacity, or range from 50% to 80%, inclusive. Optionally, the proportion of the plateau capacity in the sodium-ion battery may be 50%, 55%, 60%, 65%, 70%, 75%, 80% of the overall capacity, or within the ranges between any two of the above values, inclusive.

### BRIEF DESCRIPTION OF THE DRAWING(S)

FIG. 1A shows MALDI-TOF spectra of the phenolic-formaldehyde oligomers of Preparation Examples 1 and 2 (PE1 and PE2).

FIG. 1B shows FT-IR spectra of the phenolic-formaldehyde oligomers of Preparation Examples 1 to 3 (PE1 to PE3).

FIG. 1C shows an FT-IR spectrum in the fingerprint region of the phenolic-formaldehyde oligomer of PE1.

FIG. 1D shows an FT-IR spectrum in the fingerprint region of the phenolic-formaldehyde oligomer of PE2.

FIG. 1E shows an FT-IR spectrum in the fingerprint region of the phenolic-formaldehyde oligomer of PE3.

FIG. 2A shows a ¹³C-ssNMR spectrum of the ON resin.

FIG. 2B shows a ¹³C-ssNMR spectrum of the RN resin.

FIG. 2C shows the distribution of the amorphous and rigid regions of the ON and RN resins at different temperatures, as analyzed by ¹H-ssNMR.

FIG. 2D shows the temperature-dependent T₂ variations of the ON and RN resins, as analyzed by ¹H-ssNMR.

FIG. 2E shows the temperature-dependent T₂′ variations of the ON and RN resins, as analyzed by ¹H-ssNMR.

FIG. 2F shows TGA curves of the ON and RN resins.

FIG. 2G shows DTG curves of the ON and RN resins.

FIG. 2H shows a TGA-FTIR spectrum of the ON resin.

FIG. 2I shows a TGA-FTIR spectrum of the RN resin.

FIG. 3A shows nitrogen adsorption isotherms of the hard carbon materials of Examples 1 to 6 (E1 to E6).

FIG. 3B shows oxygen adsorption isotherms of the hard carbon materials of E1 to E6.

FIG. 3C shows carbon dioxide adsorption isotherms of the hard carbon materials of E1 to E6.

FIG. 3D shows XRD patterns of the hard carbon materials of E1 to E3.

FIG. 3E shows XRD patterns of the hard carbon materials of E4 to E6.

FIG. 3F shows Raman spectra of the hard carbon materials of E1 to E3.

FIG. 3G shows Raman spectra of the hard carbon materials of E4 to E6.

FIG. 3H shows HRXPS data of E2 and E5.

FIG. 3I shows an HRTEM image of the hard carbon material of Example 2 (ON-HC1000).

FIG. 3J shows an HRTEM image of the hard carbon material of Example 5 (RN-HC1000).

FIG. 3K shows the SAED patterns of the hard carbon materials of E2 and E5.

FIG. 4A shows the GCD curves of the half cells of lithium-ion batteries using the hard carbon materials of Comparative Example 1 (C1) and E1 to E3.

FIG. 4B shows the GCD curves of the half cells of lithium-ion batteries using the hard carbon materials of Comparative Example 2 (C2) and E5 to E7.

FIG. 4C shows the GCD curves of the half cells of lithium-ion batteries using the hard carbon materials of E2, E5, and E8.

FIG. 4D shows the GCD curves of the half cells of lithium-ion batteries using the hard carbon materials of E5, E9, and E10.

FIG. 4E shows the correlation between the plateau region capacity of Li-ion storage and the closed pore volume of hard carbon materials.

FIG. 4F shows the GCD curves of the half cells of lithium-ion batteries using the hard carbon material of E4 and the commercial hard carbon (HCN2L).

FIG. 4G shows the rate performance of half cells of lithium-ion batteries using the hard carbon material of E2, graphite (MG11), and commercial hard carbon (HCN2L).

FIG. 4H shows the specific capacity and coulombic efficiency of the half cell of a lithium-ion battery using the hard carbon material of E2 during cycling at a low current density.

FIG. 4I shows the specific capacity and coulombic efficiency of the half cell of a lithium-ion battery using the hard carbon material of E2 during cycling at a high current density.

FIG. 4J shows the charge/discharge curves of a full cell of a lithium-ion battery in the E2/LiFePO₄ configuration assembled with the hard carbon material of E2 at various charge/discharge rates.

FIG. 4K shows a GCD curve of a half cell of a sodium-ion battery using the hard carbon material of E2.

### DETAILED DESCRIPTION OF THE PREFERRED EMBODIMENTS

Hereinafter, multiple examples are provided to illustrate the implementation of preparing hard carbon materials having closed pores of the instant disclosure, while multiple comparative examples are provided as comparisons. One person skilled in the art can easily realize the advantages and effects of the instant disclosure from the following examples and comparative examples. It should be understood that the examples proposed herein are just for the purpose of illustrations only, not intended to limit the scope of the instant disclosure. Various modifications and variations could be made in order to practice or apply the instant disclosure without departing from the spirit of the instant disclosure.

### <Phenolic-Formaldehyde Oligomer>

### Preparation Example 1 (PE1): ON Oligomer

In the instant preparation example, zinc diacetate (Zn(Ac)₂) was used as the acid catalyst. Phenols and formaldehydes underwent a recondensation reaction in the presence of the acid catalyst to synthesize a phenolic-formaldehyde oligomer with a highly ortho-oriented arrangement, i.e., high-ortho Novolak oligomer, abbreviated as the ON oligomer.

The synthesis reaction of the ON oligomer is as follows:

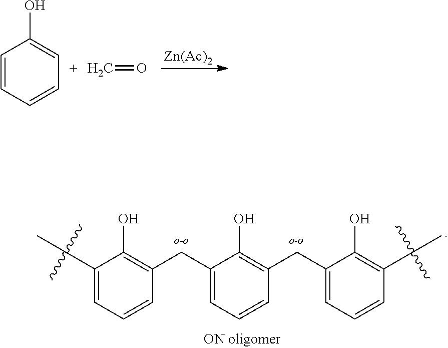

Specifically, ON oligomer of Preparation Example 1 was prepared by reacting 10 grams (g) of phenol with 6.9 milliliters (mL) of 37% formaldehyde solution in the presence of zinc diacetate (5 wt % relative to phenol) at 90° C. for 6 hours (hr) under an N₂ atmosphere with reflux. Then the reaction mixture was distilled under a reduced pressure to remove residual water and unreacted phenol.

### Preparation Example 2 (PE2): RN Oligomer

The phenolic-formaldehyde oligomer of Preparation Example 2 was also prepared by acid-catalyzed manner. The differences between PE1 and PE 2 lie in that oxalic acid (5 wt % relative to phenol) was used as the acid catalyst instead of zinc diacetate to synthesize a random Novolak oligomer, abbreviated as the RN oligomer.

The synthesis reaction of the RN oligomer is as follows:

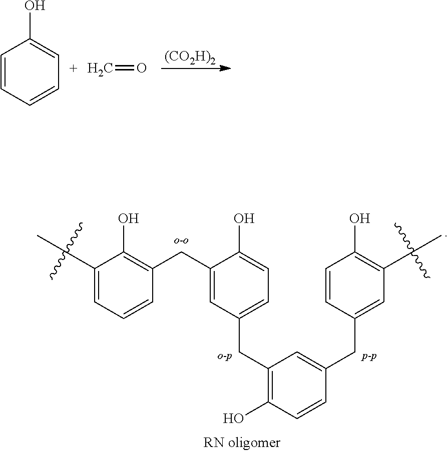

### Preparation Example 3 (PE3): ON′ Oligomer

The phenolic-formaldehyde oligomer of Preparation Example 3 was mainly prepared by the method as stated in PE1, except that the amount of zinc diacetate relative to phenol was reduced to 1 wt %. Another Novolak oligomer with highly ortho-oriented arrangement, hereinafter abbreviated as the ON′ oligomer, was obtained.

### MALDI-TOF

The phenolic-formaldehyde oligomers prepared by the foresaid preparation examples were analyzed by using a matrix-assisted laser desorption/ionization time-of-flight mass spectrometer (MALDI-TOF mass spectrometer, model: MALDI-7090 TOF/TOF, purchased by Shimadzu). In the sample preparation, 2,5-dihydroxybenzoic acid (DHB) was used as the matrix. 10 mg of phenolic-formaldehyde oligomer was dissolved in 1 mL of DHB, and added with 1 mL of 0.1 M sodium chloride solution to enhance ion formation.

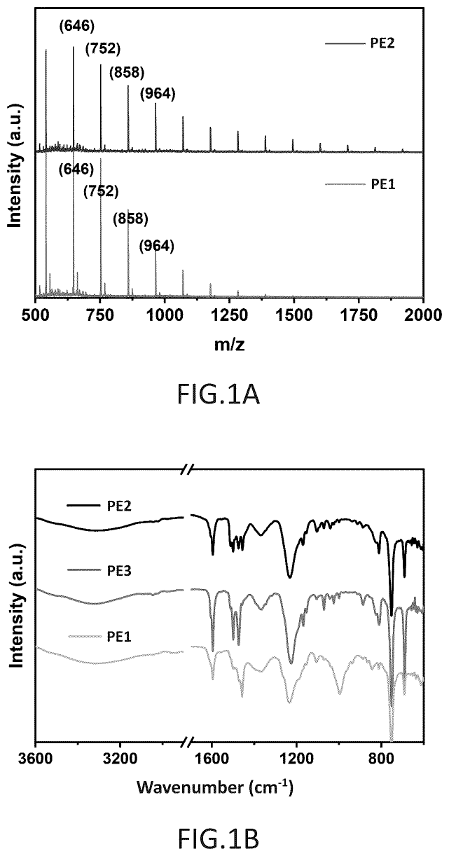

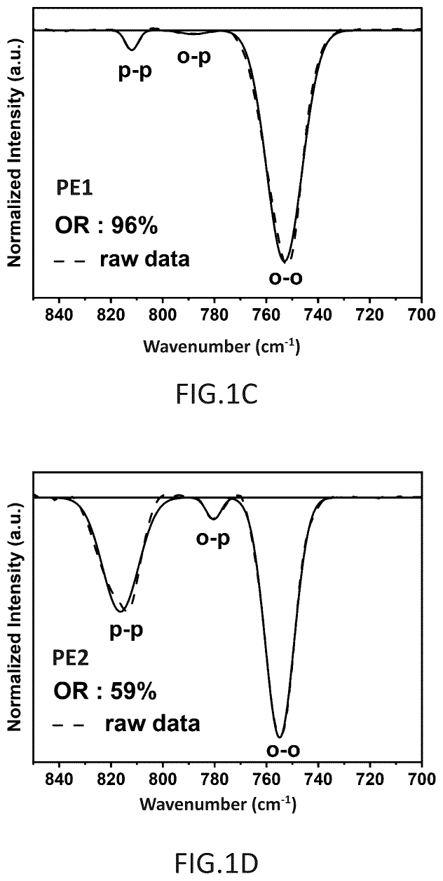

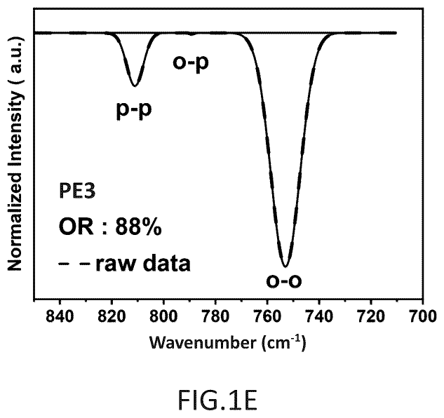

As shown in FIG. 1A, the mass-to-charge ration (m/z) spacing of 106 Dalton (Da) confirms that the benzene rings in PE1 and PE2 were connected through methylene bridges, corresponding to the monomer structure of the phenolic-formaldehyde oligomers. The molecular weight (MW) of the phenolic-formaldehyde oligomers could be calculated from the equation:

$$MW = 1 ( {H}^{+} ) or 23 ( {Na}^{+} ) + 106 m + 2 \times molecurlar weight of end group s ,$$

where m represents the number of repeating units.

The results from MALDI-TOF indicate that ON oligomer of PE1 forms more oligomers of reduced molecular weight than RN oligomer of PE2, and the molecular weight distributions of the ON and RN oligomers are different.

### FT-IR

Fourier-transform infrared spectroscopy (FT-IR, model: Nicolet iS50, brand: Thermo Fisher Scientific) combined with an attenuated total reflectance (ATR, model: Pike Miracle) accessory was applied to characterize the chemical structures of the phenolic-formaldehyde oligomers. The phenolic-formaldehyde oligomers made from the previous preparation examples were each directly dripped onto the germanium crystal plates for the measurement.

As shown in FIG. 1B, a reference band of 1610 cm⁻¹, corresponding to the stretching of aromatic ethylene bonds (C═C) in the aromatic rings, was used. PE1 to PE3 exhibited characteristic peaks of the phenolic-formaldehyde structures: O-H stretching (O-H (s)) at 3300 cm⁻¹, C-H stretching (C-H (s)) at 2900 cm 1, C-H bending vibrations (C-H (b)) at 1437 and 1330 cm⁻¹, C-O stretching (C-O) at 1200 cm⁻¹, and the peak at 1000 cm⁻¹ that only appeared in PE1 might be due to excess catalyst corresponding to the characteristic peak of residual Zn(Ac)₂.

Further, the characteristic peaks in the fingerprint region were observed in FIGS. 1C, 1D, and 1E. The stretching absorption of the methylene bridges between aromatic rings appeared at about 817 cm⁻¹ (para-para, p-p), about 774 cm⁻¹ (ortho-para, o-p), and about 752 cm⁻¹ (ortho-ortho, o-o). After the absorption areas for p-p (A(p-p)), o-p (A(o-p)), and o-o (A(o-o)) were obtained, the ortho ratios (OR) of the phenolic-formaldehyde oligomers could be estimated using the equation:

$$OR ( \% ) = \frac{A ( o - o ) + \frac{A ( o - p )}{2}}{A ( o - o ) + A ( o - p ) + A ( p - p )} \times 100 \% .$$

Results of FT-IR reveal that the ortho ratio of ON oligomer of PE1 reached as high as 96% and the ortho ratio of ON′ oligomer of PE3 reached up to 88%, confirming the successful synthesis of the phenolic-formaldehyde oligomers with a highly ortho-oriented and regular arrangement. The ortho ratio of the phenolic-formaldehyde oligomer of PE2 was about 59%, indicating the existence of ortho-ortho, para-para, ortho-para bridges in a random arrangement. It confirms that the synthesized phenolic-formaldehyde oligomer was an RN oligomer.

[symbol]

Phenolic-Formaldehyde Resin

[symbol]

1 g of the phenolic-formaldehyde oligomer (as prepared in PE1, PE2, and PE3, respectively) was mixed with polyvinyl alcohol (PVA, 5 wt % relative to the amount of the phenolic-formaldehyde oligomer), 0.5 g of hexamethylenetetramine (HMTA, purchased from SHOWA), 2 mL of ethanol, and 20 mL of deionized water. The mixture was transferred into a sealed reaction tube and placed in a microwave reactor (purchased from CEM Discover) set at a temperature of about 150° C. and with a power of about 100 watts. The reaction was continuously stirred at 150° C. for 20 minutes to ensure a uniform cross-linking and curing reaction through the microwave-assisted suspension polymerization.

Once cooled to room temperature, yellow Novolak resins were observed suspended in water, which were subsequently rinsed with acetone to remove excess reactants. The cured Novolak resins were then filtered and dried under vacuum at 80° C. for 24 hr, and the cured Novolak resin spheres were obtained.

After the cross-linking and curing reaction, the phenolic-formaldehyde resin prepared by the ON oligomer of PE1 as raw materials is named “ON resin”, the resin prepared by the RN oligomer of PE2 is named “RN resin”, and the resin prepared by the ON′ oligomer of PE3 is named “ON′ resin”.

In addition to the foresaid method of the phenolic-formaldehyde resins, 1 g of the phenolic-formaldehyde oligomer of Preparation Example 2 was mixed with PVA (5 wt % relative to the phenolic-formaldehyde oligomer), 0.1 g of HMTA, 2 mL of ethanol, and 20 mL of deionized water. Under the same conditions as stated above, the mixture underwent a uniform cross-linking and curing reaction through the microwave-assisted suspension polymerization. After cooling, the resins were rinsed, filtered, and dried as stated above to obtain RN′ resin.

Also, 1 g of the phenolic-formaldehyde oligomer of Preparation Example 2 was mixed with PVA (5 wt % relative to the phenolic-formaldehyde oligomer), 1 g of HMTA, 2 mL of ethanol, and 20 mL of deionized water. Under the same conditions, the mixture underwent a uniform cross-linking and curing reaction through the microwave-assisted suspension polymerization. After cooling, the resins were rinsed, filtered, and dried as stated above to obtain RN″ resin.

### ¹³C-ssNMR

To investigate the molecular structure of the obtained phenolic-formaldehyde resins, ¹³C solid-state nuclear magnetic resonance (¹³C-ssNMR, model: Bruker AVANCE III 400 MHz) combined with cross-polarization magic angle spinning (CP/MAS) technique was adopted to analyze the ON resin and RN resin. Ortho ratios of the phenolic-formaldehyde resins were obtained.

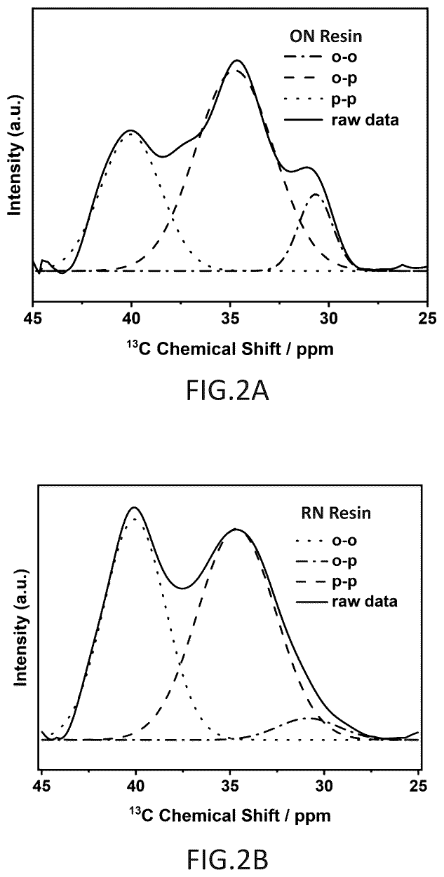

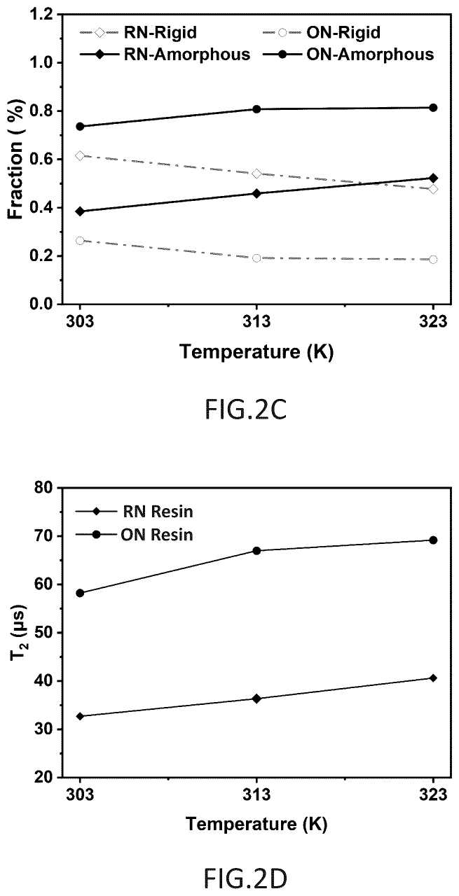

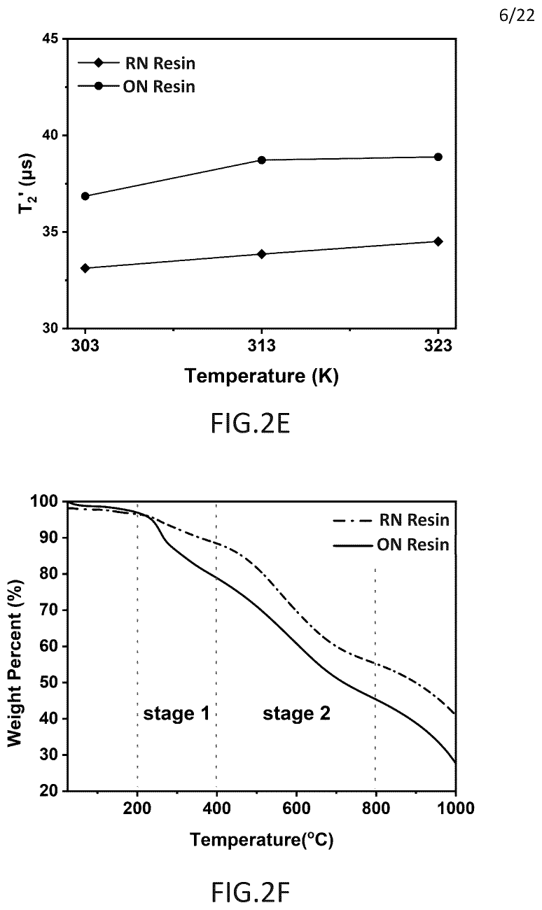

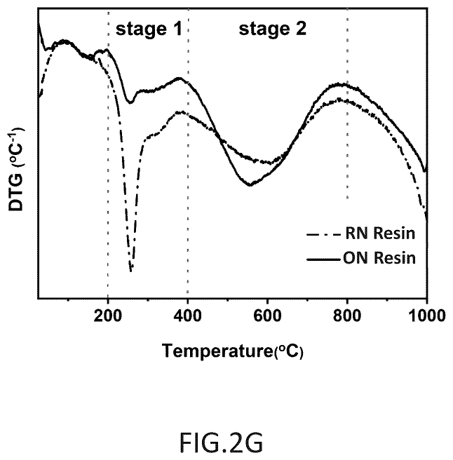

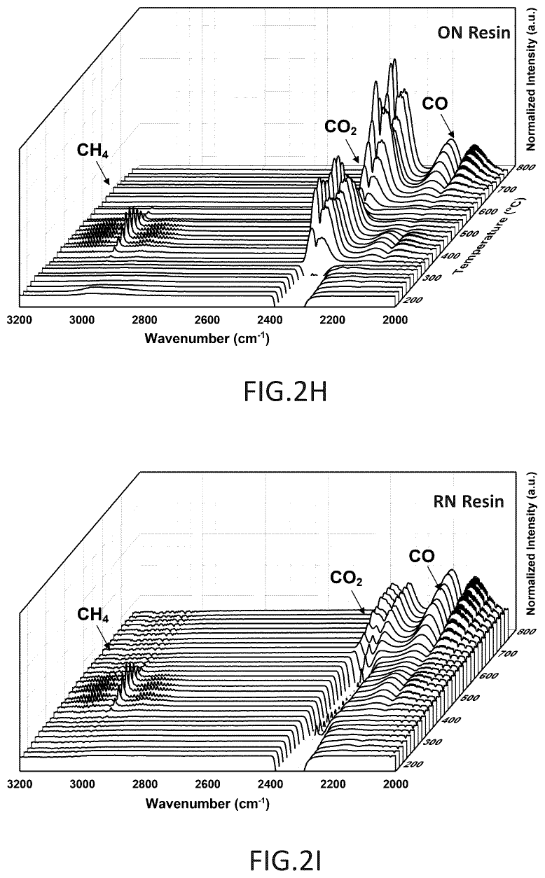

With reference to FIGS. 2A and 2B, the characteristic peaks of carbons on ortho-ortho, ortho-para, and para-para bridges can be distinguished at approximately 30 ppm, 35 ppm, and 40 ppm, respectively. The ortho ratio (OR) of the phenolic-formaldehyde resins could be calculated from the integration of signals (A(p-p), A(o-p), and A(o-o)) by the following equation:

$$OR ( \% ) = \frac{A ( o - o ) + \frac{A ( o - p )}{2}}{A ( o - o ) + A ( o - p ) + A ( p - p )} \times 100 \% .$$

It can be realized that the higher ortho ratio of the phenolic-formaldehyde resin indicates more ortho carbons of the phenolic groups in the phenolic-formaldehyde resin were bonded or cured with the methylene bridges.

Results of ¹³C-ssNMR indicate that the ortho ratios of ON resin and RN resin were 35% and 26%, respectively, confirming that ON resin, which was formed by curing the ON oligomer of PE1, still retained higher ortho ratio. The results could correspond to the integrated signals of free-ortho carbons at 115 ppm and of free-para carbons at 120 ppm. Specifically, the reduced integrated signal at 115 ppm of ON resin indicates that most of ortho carbons of the phenolic groups in the phenolic-formaldehyde resin were reacted, indicating that ON resin had higher ortho ratio than RN resin.

Further, according to the equation below, the cross-linking density (CLD) of the phenolic-formaldehyde resin could be calculated by dividing the sum of the integrated area of the ortho-ortho, ortho-para, and para-para bridges by the integrated area (A(phenolic-OH)) of the peak at 150 ppm to 155 ppm. The results are listed in Table 1 below.

$$CLD = \frac{A ( o - o ) + A ( o - p ) + A ( p - p )}{A ( phenolic - OH )} .$$

TABLE 1
results of ¹³C-ssNMR, ortho ratios and cross-linking densities of
the phenolic-formaldehyde resins

| | ON resin | RN resin |
|---|---|---|
| A(phenolic-OH) @150 ppm | 684605000 | 539823000 |
| to 155 ppm | | |
| A (o-o) @30 ppm | 37702900 | 17886100 |
| A (o-p) @35 ppm | 269355000 | 235778000 |
| A (p-p) @40 ppm | 191254000 | 273768000 |
| Ortho-ortho (%) | 7.57 | 3.39 |
| Ortho-para (%) | 54.05 | 44.70 |
| Para-para (%) | 38.38 | 51.91 |
| Free ortho (%) | 16.39 | 57.57 |
| Free para(%) | 83.61 | 42.43 |
| OR (%) | 35 | 26 |
| CLD | 0.73 | 0.98 |

In the above Table 1, based on the sum of the integrated area of the ortho-ortho, ortho-para, and para-para signals, the integrated area ratio of the ortho-ortho signal is represented by “o-o”, the integrated area ratio of the ortho-para signal is represented by “o-p”, and the integrated area ratio of the para-para signal is represented by “p-p”. Based on the sum of the integrated area of the free-ortho and free-para signals, the respective ratios of the integrated area of the free-ortho and free-para are listed in Table 1.

From Table 1, CLD values of ON resin and RN resin were respectively 0.73 and 0.98, indicating that RN resin had more phenolic ring linkages compared to ON resin. Compared to ON oligomers in PE1, RN oligomers of PE2 with a lower ortho ratio underwent random bonding during the cross-linking and curing reaction, thereby forming more phenolic ring linkages in the RN resin. As a result, the RN resin exhibited a higher cross-linking density than the ON resin.

In addition, from the comparison of the preparation of RN, RN′, and RN″ resins, the cross-linking densities of the phenolic-formaldehyde resins could be adjusted by the amounts of the cross-linking reagents. That is, the cross-linking density of the phenolic-formaldehyde resin can be increased by increasing the amount of the cross-linking reagents.

¹H-ssNMR

¹H-ssNMR (German BRUKER, AVIII 600 WB, 600 MHz) measurements were conducted at temperatures of 303K, 313K, 323K, and the corresponding free induction decay (FID) was fitted by using the following equation, so as to evaluate the molecular motion ability of the phenolic-formaldehyde resins.

$$Y = A {e}^{- \frac{t}{{T}_{2}}} + {Be}^{{( - \frac{t}{{T}_{2}^{′}} )}^{2}}$$

In the above equation, A represents the amorphous fraction of the phenolic-formaldehyde resin at a specific temperature, B represents the rigid fraction of the phenolic-formaldehyde resin, and T₂ and T₂′ are respectively the spin-spin relaxation time of the amorphous fraction and the rigid fraction, whose units are microseconds (μs).

According to Bloembergen-Purcell-Pound (BPP) theory, spin-spin relaxation time increases as the molecular motion accelerates.

By fitting the FID data of ON and RN resins at different temperatures, the results are displayed in FIGS. 2C to 2E. As shown in FIG. 2C, the rigid fraction of ON resin and RN resin decreased with increasing temperature, and the amorphous fractions of the ON resin at three temperature conditions were higher than those of the RN resin. FIGS. 2D and 2E reveal that the T₂ and T₂′ values for the ON resin were higher than those for the RN resin.

It can be seen that the ON resin had greater molecular motion ability than the RN resin, confirming again that the ON resin has a lower cross-linking density than the RN resin.

### TGA & DTG

The phenolic-formaldehyde resins were analyzed by a thermogravimetric analyzer (TGA, model: 2-HT, brand: Mettler-Toledo). The measurements were conducted from room temperature to 1000° C. at a heating rate of 10° C./min under a nitrogen atmosphere to measure the temperature-dependent mass loss rates.

From the TGA curves in FIG. 2F and derivative thermogravimetric curves (DTG curves) in FIG. 2G, RN resin and ON resin kept stable without apparent mass loss at a temperature below 200° C. However, significant thermal decomposition behavior began being observed over 200° C. Decomposition occurred at two stages: 200° C. to 400° C. and 400° C. to 800° C.

Stage 1 (200° C. to 400° C.) was mainly attributed to the recondensation reaction, and stage 2 (400° C. to 800° C.) was mainly attributed to the formation of pure carbon rings (sp²). As the ON resin had a higher ortho ratio, a greater number of unreacted free-para sites were able to undergo the recondensation reaction, resulting in the stronger exothermic signal in stage 1 than the RN resin. After most of the reactive free-para sites are depleted, only the less reactive ortho sites and mostly nonreactive meta sites remained, such that these two phenolic-formaldehyde resins showed similar exothermic behavior in stage 2. It reveals that the phenolic-formaldehyde resin with a lower cross-linking density undergoes a more complete carbonization process under the same thermal treatment compared with the resin with a higher cross-linking density.

### TGA-FTIR

Further, TGA was combined with FT-IR to detect the released gas-phase molecules during the pyrolysis and evaluate the real-time gas evolution. Specifically, the samples were also heated from room temperature to 1000° C. at a heating rate of 10° C./min under a nitrogen atmosphere, and the TGA-FTIR data were collected within the range of 200° C. to 800° C.

As shown in FIGS. 2H and 2I, when the temperature exceeded 300° C., the characteristic signals representing carbon monoxide (C-O) around the range of 2000 cm⁻¹ to 2250 cm⁻¹ and carbon dioxide (C═O) around the range of 2250 cm⁻¹ to 2400 cm⁻¹ appeared in the spectrum of the ON resin. This indicates that the more drastic recondensation reaction occurred during the thermal treatment of ON resin, which aligns with the results of DTG analysis. When the temperature increased over 400° C., both ON resin and RN resin had intensive release of CO and CO₂, revealing the formation of pure carbon rings.

[symbol]

Hard Carbon Material

[symbol]

The cured Novolak resin spheres, as previously prepared ON, ON′, RN, RN′, and RN″ resins, were placed in a carbonization furnace with a heating rate of 100° C./hr and carbonized at various carbonization temperatures for 6 hr under an argon atmosphere, yielding the hard carbon materials. The type of the phenolic-formaldehyde resins and carbonization temperatures used in each example are listed in Tables 2-1, 2-2, and 3.

To investigate the influences of the resin type and carbonization temperature on the characteristics of the hard carbon materials, the ON resins were carbonized at respective carbonization temperatures of 600° C., 800° C., 1000° C., and 1200° C. to yield the hard carbon materials of Comparative Example 1 and Examples 1 to 3, and the RN resins were carbonized at respective carbonization temperatures of 600° C., 800° C., 1000° C., 1200° C., and 1400° C. to yield the hard carbon materials of Comparative Example 2, and Examples 4 to 7.

In other embodiments, the ON′, RN′, and RN″ resins were carbonized at carbonization temperatures of 1000° C. to respectively obtain the hard carbon materials of Examples 8 to 10.

### Pore Analysis

To investigate the pore morphology and distribution, the hard carbon materials were measured with a surface area and porosity analyzer (brand: Micromeritics, model: ASAP 2020). For a further comparison with the conventional hard carbon, the commercial hard carbon (model: HCN2L, purchased from UBIQ Technology Cooperation) was selected as a sample in the following experiments to investigate the pore morphology.

Before gas adsorption/desorption analyses, the hard carbon materials were completely degassed at 120° C. under high vacuum (less than 1 μmHg) overnight. The analysis bath temperatures were 77 K for both N₂ and O₂, and 273 K for CO₂, respectively, so as to obtain the total pore volume determined by various gas adsorption analyses.

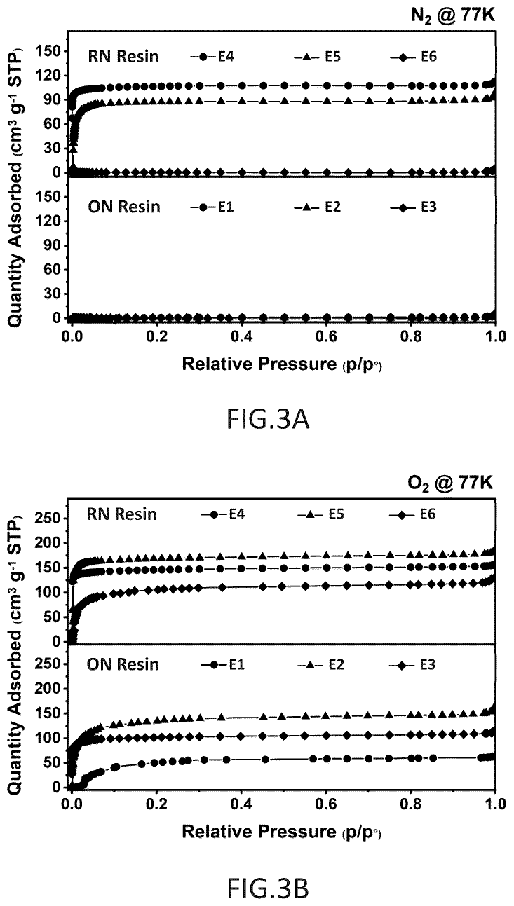

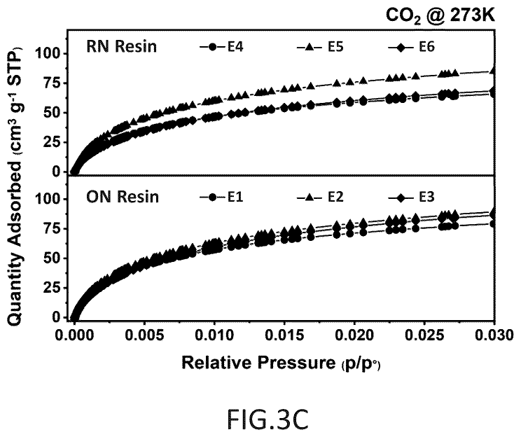

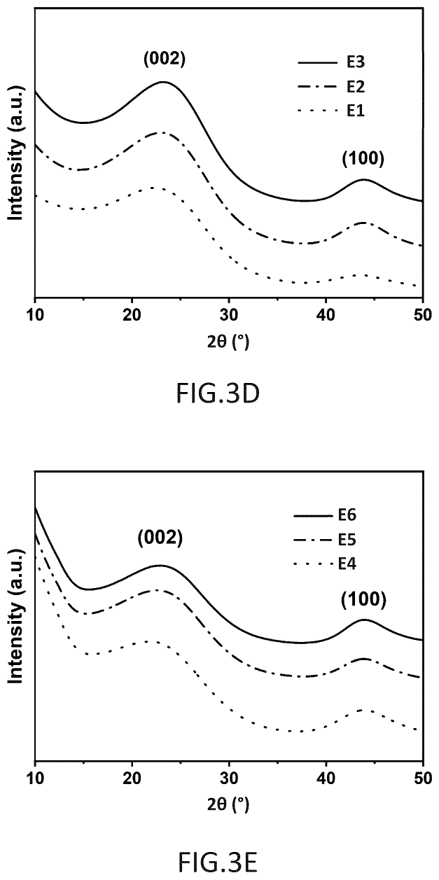

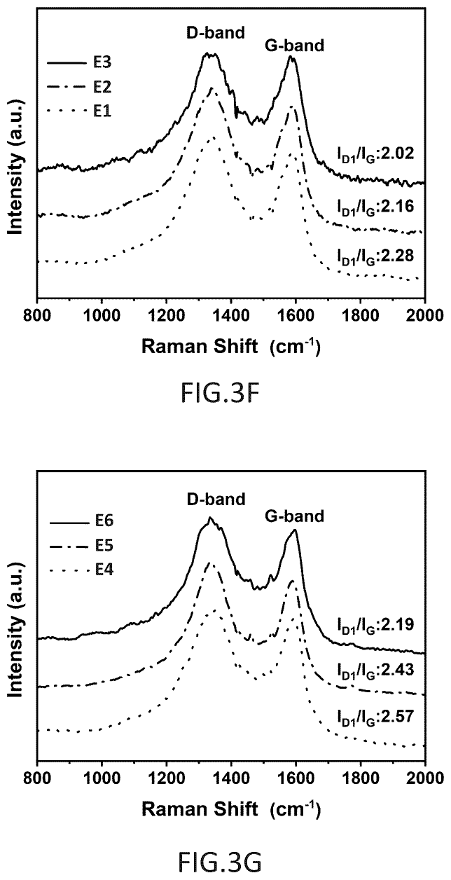

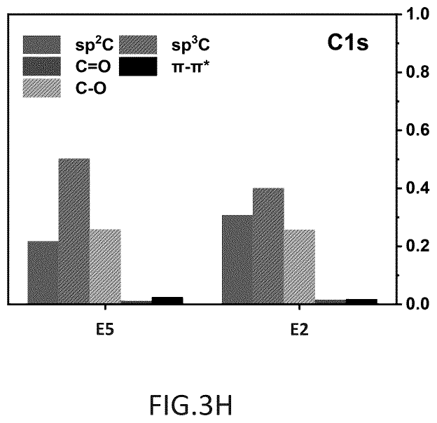

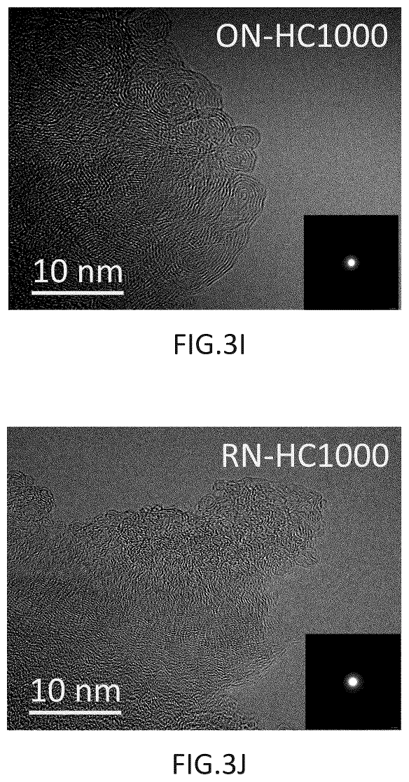

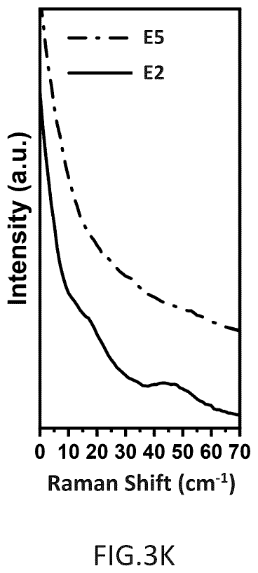

The specific surface areas based on the BET theory were calculated from the adsorption isotherms in the relative pressure range from 0.01 to 0.3 P/P₀ for N₂ and O₂, and from 0.001 to 0.03 P/P₀ for CO₂. The results are shown in FIGS. 3A to 3C and Table 2-1.

In multiple gas adsorption analyses, O₂ could penetrate the confined spaces (closed pore), but N₂ is unable to access due to differences in molecular size and atomic affinity, the information of the closed but not open pores in the hard carbon material could be revealed. Further, CO₂ preferentially diffuses into relatively narrow pores, thus it can be chosen as adsorbates to facilitate the measurement of ultramicropore volume with a pore size less than 0.7 nm.

The total pore volume (Vt_{O}_{₂}) determined by O₂ adsorption analysis includes the volume of both open and closed pores. The total pore volume (Vt_{N}_{₂}) determined by N₂ adsorption analysis mainly reflects the volume of the open pores. As the total pore volume (Vt_{CO}_{₂}) determined by CO₂ adsorption analysis may also include the volume of open pores, only the volume (Vt_{CO}_{₂}<0.7 nm) of ultramicropore with a pore size less than 0.7 nm was calculated in this experiment. After obtaining the aforementioned measurement data, the closed pore volume (V_{closed}) can be obtained by using the following equation, and the detailed results are shown in Table 2-2 below.

$${V}_{c l o s e d} = {Vt}_{{O}_{2}} + {Vt}_{{CO}_{2} < 0.7 nm} - {Vt}_{{N}_{2}}$$

TABLE 2-1
the specific surface area of the hard carbon materials of Examples
1 to 7 (E1 to E7) and Comparative Example 1 (C1) as well as
the commercial hard carbon (HCN2L) determined by multiple
gas adsorption analyses

| | | Carbonization | | | |
|---|---|---|---|---|---|
| | | Temperature | Specific surface area (m²/g) | | |
| | Resin | (° C.) | N₂ | O₂ | CO₂ |
| HCN2L | — | — | 0.642 | 0.665 | about 0 |
| C1 | ON | 600 | 277.102 | 313.926 | 205.611 |
| E1 | ON | 800 | 3.671 | 175.309 | 366.741 |
| E2 | ON | 1000 | 2.288 | 397.655 | 440.94 |
| E3 | ON | 1200 | 1.261 | 278.811 | 438.025 |
| E4 | RN | 800 | 354.781 | 398.244 | 322.665 |
| E5 | RN | 1000 | 284.278 | 473.096 | 419.218 |
| E6 | RN | 1200 | 1.269 | 298.383 | 345.321 |
| E7 | RN | 1400 | 1.162 | 107.184 | 323.301 |

TABLE 2-2
the total pore volume and closed pore volume (V_{closed}) of the hard
carbon materials of E1 to E7 and C1 as well as the commercial hard
carbon (HCN2L) determined by multiple gas adsorption analyses

| | | Carbonization | | | | | |
|---|---|---|---|---|---|---|---|
| | | Temperature | Total pore volume (cm³/g) | | | | V_{closed} |
| | Resin | (° C.) | N₂ | O₂ | CO₂ | CO_{2<0.7 nm} | (cm³/g) |
| HCN2L | — | — | 0.005 | 0.005 | about 0 | about 0 | about 0 |
| C1 | ON | 600 | 0.122 | 0.151 | 0.075 | 0.047 | 0.076 |
| E1 | ON | 800 | 0.007 | 0.068 | 0.158 | 0.114 | 0.175 |
| E2 | ON | 1000 | 0.006 | 0.173 | 0.181 | 0.118 | 0.285 |
| E3 | ON | 1200 | 0.004 | 0.134 | 0.176 | 0.11 | 0.24 |
| E4 | RN | 800 | 0.143 | 0.187 | 0.124 | 0.089 | 0.133 |
| E5 | RN | 1000 | 0.129 | 0.207 | 0.159 | 0.113 | 0.191 |
| E6 | RN | 1200 | 0.006 | 0.133 | 0.134 | 0.086 | 0.213 |
| E7 | RN | 1400 | 0.005 | 0.061 | 0.1 | 0.062 | 0.118 |

As shown in Table 2-2, among the hard carbon materials (Examples 1 to 3) derived from ON resins, Example 2, which was carbonized at 1000° C., exhibited the highest closed pore volume. Among the hard carbon materials (Examples 4 to 7) derived from RN resins, Example 6, which was carbonized at 1200° C., exhibited the highest closed pore volume. This indicates that the optimal temperature range for maximizing the closed pore volume differs between ON resin and RN resin. When increasing the carbonization temperature for ON resin (e.g., 1200° C. of Comparative Example 3) and RN resin (e.g., 1400° C. of Comparative Example 7), the decline in closed pore volume at higher carbonization temperatures might arise from the collapse of the closed pore structure, resulting in the decreased porosity with the formation of almost non-porous configuration. In contrast, the result obtained using the same testing method shows that the commercial hard carbon almost had no closed pores. This confirms that the porosity of the commercial hard carbon was obviously different from those of the hard carbon materials of the foresaid examples.

From the above experimental results, the temperature required for carbonization can be set according to the cross-linking density of the phenolic-formaldehyde resin to optimize the hard carbon material with a maximized closed pore volume, thereby successfully creating more closed pores in the hard carbon material. This approach not only has the advantage of energy saving, but also improves the hard carbon material to exhibit excellent charge and discharge performance in the subsequent lithium-ion battery application.

### XRD

To further investigate their microstructure, the hard carbon materials were characterized by X-ray diffraction (XRD, brand: Bruker, model: D8 Advance diffractometer) equipped with a Cu Ku radiation source (λ=1.5405 Å) at a scan rate of (2θ) 0.5° per minute. The results are shown in FIGS. 3D and 3E.

In FIGS. 3D and 3E, two broad peaks at 2θ between 200 and 300 (corresponding to the (002) plane) and at 2θ between 400 and 500 (corresponding to the (100) plane), which are typical characteristics of hard carbon materials, were observed, indicating that Examples 1 to 6 had lower crystallinity compared to soft carbon or graphite. By using the Bragg's equation, the interlayer spacing (d₀₀₂) of the pseudo graphitic structure can be calculated. By using the Scherrer's equation, the pseudo graphitic lengths along the c-axis (L_{c}) and a-axis (Lₐ) can both be calculated, and thus the number (N) of pseudo graphitic layers could be estimated.

The calculation equations are as follows.

$$λ = 2 {d}_{002} sin {θ}_{002}$$

$${L}_{c} = 0.89 λ / {β}_{002} cos {θ}_{002}$$

$${L}_{a} = 1.84 λ / {β}_{100} cos {θ}_{100}$$

$$N = {L}_{c} / {d}_{002}$$

In the above equations, β₀₀₂ is a full width at half maximum of the (002) peak, and β₁₀₀ is a full width at half maximum of the (100) peak. Results are summarized in Table 3 below.

TABLE 3
the resin type, carbonization temperature of the hard carbon materials of
E1 to E6, and their d₀₀₂, L_{c}, Lₐ, number of stacked layers, and I_{D}/I_{G} ratio

| | E1 | E2 | E3 | E4 | E5 | E6 |
|---|---|---|---|---|---|---|
| Resin | ON | ON | ON | RN | RN | RN |
| Carbonization | 800 | 1000 | 1200 | 800 | 1000 | 1200 |
| temperature (° C.) | | | | | | |
| d₀₀₂ (nm) | 0.381 | 0.377 | 0.375 | 0.384 | 0.381 | 0.378 |
| L_{c} (nm) | 0.999 | 1.019 | 1.039 | 0.987 | 0.989 | 1.015 |
| Lₐ (nm) | 2.937 | 3.719 | 3.788 | 2.892 | 3.216 | 3.493 |
| Number of | 2.624 | 2.699 | 2.769 | 2.567 | 2.596 | 2.684 |
| stacked layers | | | | | | |
| I_{D}/I_{G} | 2.28 | 2.16 | 2.02 | 2.57 | 2.43 | 2.19 |

### Raman

The hard carbon materials were each analyzed by using a Raman spectrometer (brand: ThermoFisher, model: DXRIII) with a laser excitation of 532 nm, and placed on a slide at 25° C. for the measurement. Raman results are shown in FIGS. 3F and 3G.

In Raman spectra, the broad D band at 1300 cm⁻¹, corresponding to the defective carbon structures, can acquire the defects of the carbon lattices and disorder information in the hard carbon materials. The G band at 1580 cm⁻¹ can correspond to the crystallinity of sp²-hybridized carbons. The I_{D}/I_{G} ratio, i.e., the relative intensity ratio of the D band relative to the G band obtained by integration of their area, can be evaluated for the degree of graphitization.

From the XRD and Raman results in Table 3, a higher carbonization temperature leads to the decline of d₀₀₂, the enlargement of both L_{c} and Lₐ, and the decline of I_{D}/I_{G} ratio, representing the growth of the pseudo graphitic structure. It concludes that the carbonization temperature is crucial to the degree of graphitization.

In addition, under the same carbonization temperature, the hard carbon materials of Examples 1 to 3 had a lower I_{D}/I_{G} ratio than those of Examples 4 to 6, respectively. It indicates that the hard carbon material prepared from the RN resin with a higher CLD would have a reduced degree of graphitization, while the hard carbon material prepared from the ON resin with a lower CLD included more extended pseudo graphitic structure and more stacked graphene layers under the treatment at the same carbonization temperature, exhibiting a higher degree of graphitization.

### HRXPS

A high-resolution X-ray photoelectron spectrometer (HRXPS, brand: ULVAC-PHI, Japan, model: PHI Quantera II) was also used to characterize the microstructure of the hard carbon materials. As shown in the HRXPS CIs spectra, Example 2 had a higher proportion of sp² carbons (284.5 eV) than Example 5. Other proportions of the characteristic peaks of sp³ carbons (284.9 eV), C—O bonds (286.2 eV), C═O bonds (288 eV), and π-π* satellite (290 eV) were shown in FIG. 3H.

The results obtained from the HRXPS also align with the XRD and Raman results, reconfirming that calcination at the same carbonization temperature for the phenolic-formaldehyde resin with a low CLD (ON resin of Example 2) leads to the growth of more stacked pseudo-graphene layers, exhibiting a higher degree of graphitization.

### HRTEM-SAED

High-resolution transmission electron microscopy (HRTEM, brand: JEOL, model: JEM-2100F) combined with selected area electron diffraction (SAED) was applied to observe the microstructures of the hard carbon materials of the foresaid examples and comparative examples in the nanoscale dimensions. For ease of explanations, the following discussion of results is based on the observations of the hard carbon materials of Example 2 and Example 5, both obtained under the same carbonization temperature.

As shown in FIG. 3I, hard carbon material of Example 2 (ON-HC1000) had more extended and tightly stacked graphitic layers, which was consistent with the extended Lₐ and L_{c} as well as more stacked layers in XRD analysis. In contrast, a high proportion of curved pseudo-graphene layers and larger interlayer spacing could be observed in FIG. 3J of the hard carbon material of Example 5 (RN-HC1000). As shown in FIG. 3K, the SAED pattern of Example 2 showed relatively obvious diffraction rings of the (002) plane, indicating that the hard carbon material of Example 2 had a higher degree of graphitization compared to Example 5.

It can be seen that, in addition to carbonization temperature, the cross-linking density of the phenolic-formaldehyde resin also manipulates the disorder or graphitization degree of the hard carbon material. Hence, the microstructure of the hard carbon material also can be controlled by the cross-linking density of the phenolic-formaldehyde resin.

Based on the above results, by using the phenolic-formaldehyde oligomer with a highly ortho-oriented arrangement such as PE1, the oriented arrangement can promote the synthesis of ON resin with a lower cross-linking density and the growth of more pseudo graphitic structure and more stacked pseudo-graphene layers, exhibiting the higher degree of graphitization. Thus, the use of ON resin allows the hard carbon material formed with a large number of closed pores at a relatively low carbonization temperature. In contrast, by using the phenolic-formaldehyde oligomer with a random arrangement such as PE2, the random arrangement can achieve a higher cross-linking density in RN resin, resulting in that its hard carbon material has a lower degree of graphitization. To achieve the desired amount of the closed pores, RN resin should be calcined at a higher carbonization temperature to obtain the expected hard carbon material.

[symbol]

Lithium-Ion Battery

[symbol]

To evaluate the performance that the negative electrode active materials were applied to the lithium-ion batteries, the hard carbon materials having closed pores of the foresaid examples and comparative examples, graphite (model: MG11, purchased from China Steel Chemical Cooperation) and commercial hard carbons (model: HCN2L, purchased from UBIQ Technology Cooperation) were adopted as the negative electrode active materials in the active material/Li configuration (i.e., half cells) to be evaluated, and then prepared by the same method to obtain the half cells of lithium-ion batteries for performance comparisons.

Specifically, the negative electrode active materials, carbon black (model: XC-72, purchased from Vulcan), and polyvinylidene fluoride (PVDF, purchased from Sigma Aldrich) were mixed at a weight ratio of 85:5:10. The mixture was dispersed in N-methyl-2-pyrrolidone (NMP) at room temperature overnight to ensure homogeneity, and then a well-mixed electrode slurry was obtained.

After that, the electrode slurry was coated onto the copper foil. The mass loading of the negative electrode active materials (the previous hard carbon materials) for each 1 cm² of copper foil were about 1 mg. The copper foil coated with the electrode slurry was dried at 70° C. under vacuum overnight, and the carbon-coated electrode was obtained.

The samples of all half-cell electrochemical measurements were prepared by using the CR2032 coin cell with a carbon-coated electrode and a lithium foil separated by a glass fiber membrane (grade: GF/A) in each case. The electrolyte consisted of 1 M lithium hexafluorophosphate (LiPF₆) in a mixed solvent of ethylene carbonate (EC, battery grade with purity ≥99%, purchased from Sigma Aldrich), ethyl methyl carbonate (EMC, purity ≥99%, purchased from Sigma Aldrich), and dimethyl carbonate (DMC, anhydrous, purity ≥99%, purchased from Sigma Aldrich) with a volume ratio of 1:1:1. 100 μL of the electrolyte was dripped into each coin cell case, and then the half cells of lithium-ion batteries for examples and comparative examples were assembled into samples for the subsequent electrochemical measurements.

To prevent moisture contamination, all cells were assembled in an Ar-filled glove box (H₂O and O₂ contents were both less than 0.1 ppm). The water content of the electrolyte was confirmed to be below 30 parts per million (ppm) by the Karl Fischer titration with 831 KF Coulometer (brand: Metrohm).

### GCD

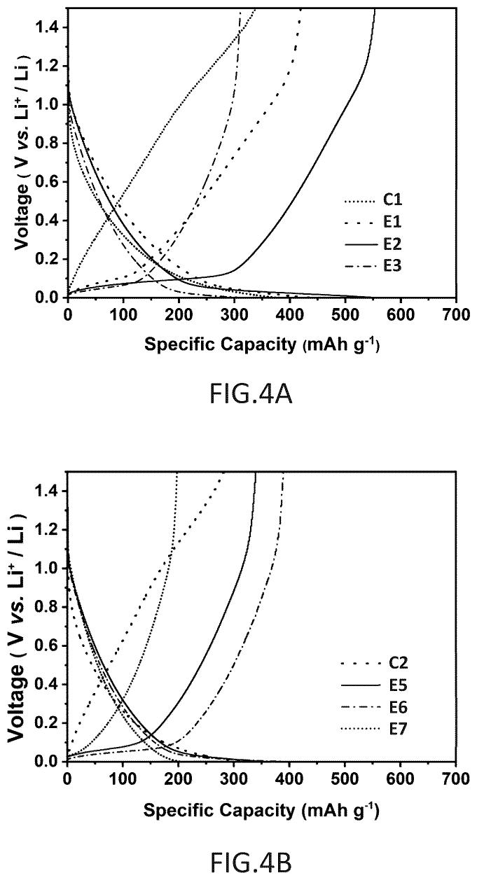

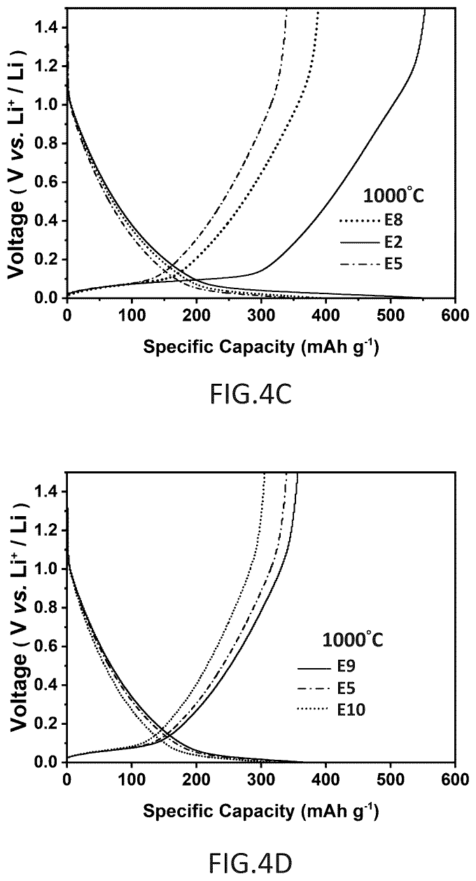

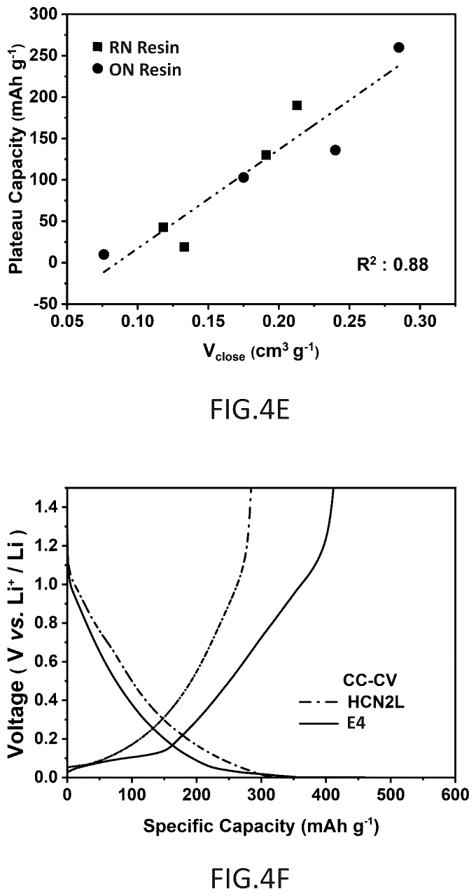

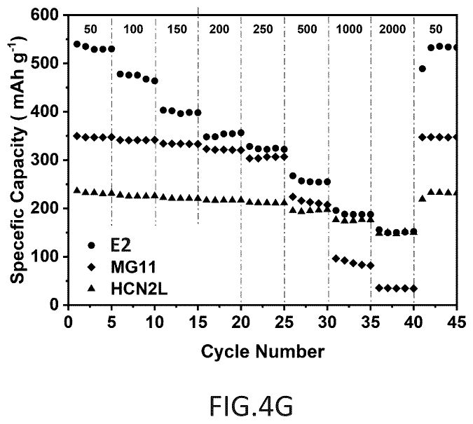

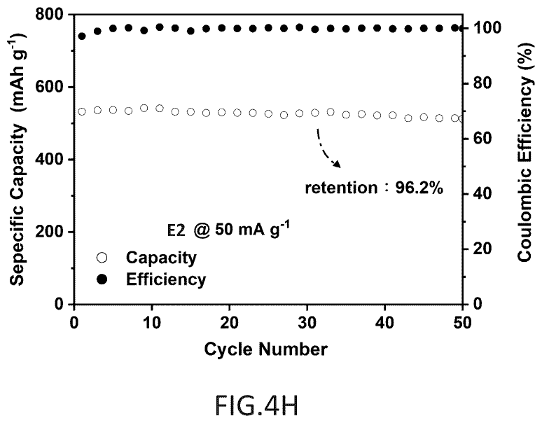

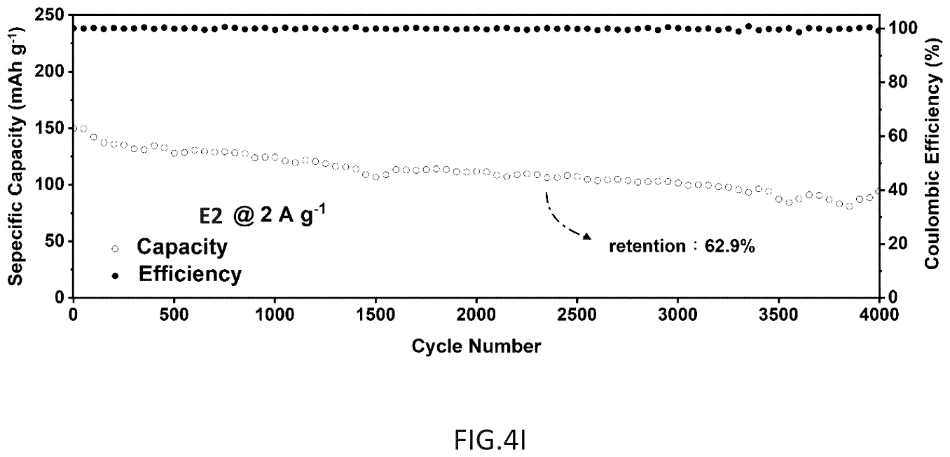

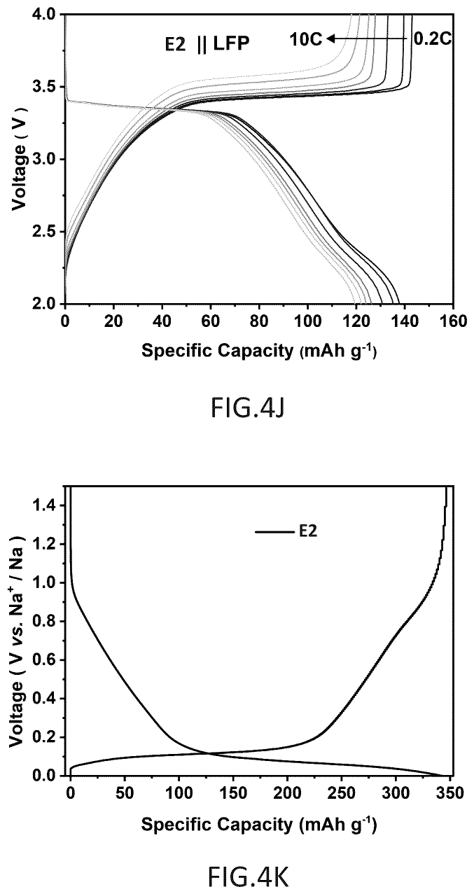

The half cells of lithium-ion batteries assembled by the previous method were adopted as samples. Galvanostatic charge/discharge (GCD) cycle testing of the half cells was performed by using an electrochemical analyzer (model: CHI6273E, brand: CH Instruments) at room temperature. The operating voltage window ranged from 0.001 V to 1.5 V (vs. Li⁺/Li), and the current density was set at 50 mA/g. The results are shown in FIGS. 4A to 4D.

The obtained GCD curves can be featured into a plateau region (at voltages below 0.1 V) and a sloping region (at voltages above 0.1 V). The capacities corresponding to the plateau region and the sloping region and the overall capacity for the half cells are listed in Table 4.

In addition, the types of the chosen phenolic-formaldehyde resin, the cross-linking densities, the carbonization temperatures, and the corresponding closed pore volume are summarized in Table 4 to facilitate the investigation of how the type of phenolic-formaldehyde resin, the cross-linking density, and the carbonization temperature affect the closed pore volume of hard carbon materials and also to further explore the correlation between the closed pore volume and the plateau region capacity of the lithium-ion storage.

The results in Table 4 reveal that the phenolic-formaldehyde resins thermally treated at the carbonization temperatures ranging from 700° C. to 1500° C. are favorable for generating the desired closed pore volume in hard carbon materials. Therefore, such hard carbon material applied to the lithium-ion batteries as the negative electrode active materials can enhances the plateau region capacity, thereby enhancing the overall capacity.

TABLE 4
the types and cross-linking densities of the phenolic-formaldehyde resins of examples
and comparative examples combined with their carbonization temperatures and closed
pore volume, and the capacity data of the half cells of lithium-ion batteries
assembled from various hard carbon materials and commercial hard carbon.

| | | | Carbonization | | Capacity (mAh/g) | | |
|---|---|---|---|---|---|---|---|
| | | | temperature | V_{closed} | Plateau | Sloping | Overall |
| | Resin | CLD | (° C.) | (cm³/g) | region | region | capacity |
| C1 | ON | 0.73 | 600 | 0.076 | 11 | 324 | 335 |
| E1 | ON | 0.73 | 800 | 0.175 | 103 | 315 | 418 |
| E2 | ON | 0.73 | 1000 | 0.285 | 255 | 295 | 550 |
| E3 | ON | 0.73 | 1200 | 0.24 | 136 | 175 | 311 |
| C2 | RN | 0.98 | 600 | 0.122 | 10 | 286 | 296 |
| E5 | RN | 0.98 | 1000 | 0.191 | 130 | 210 | 340 |
| E6 | RN | 0.98 | 1200 | 0.213 | 190 | 200 | 390 |
| E7 | RN | 0.98 | 1400 | 0.118 | 43 | 178 | 221 |
| HCN2L | — | — | — | about 0 | 10 | 230 | 240 |

As shown in FIGS. 4A and 4C, the carbonization temperature set between 700° C. and 1400° C. for ON resins resulted in the hard carbon materials of Examples 1 to 3 with the desired closed pore volume, thereby enhancing the plateau region capacity of the lithium-ion storage. In contrast, the carbonization temperature of Comparative Example 1 was too low to effectively carbonize the phenolic-formaldehyde resin into a hard carbon material with the desired closed pore volume, resulting in that the half cell prepared from Comparative Example 1 had a reduced plateau region capacity and a reduced overall capacity as well.

For RN resins, as shown in FIGS. 4B and 4D, tuning the carbonization temperature in a higher range from 800° C. to 1500° C. or from 900° C. to 1400° C. effectively created a desired closed pore volume in the hard carbon materials of Examples 5 to 7, and 9 and 10, and thus the half cells of lithium-ion batteries exhibited the higher plateau region capacity and higher overall capacity than that of Comparative Example 2.

Regardless of whether the ON resin of a low CLD or the RN resin of a high CLD was used, the plateau region capacity and the overall capacity of lithium-ion battery gradually rose and fell with increasing the carbonization temperature, exhibiting a volcano-like behavior, when the hard carbon materials were used as the negative electrode active materials in the lithium-ion batteries. Specifically, for the ON resins, utilizing the hard carbon material, whose carbonization temperature was set at 1000° C., ensured its lithium-ion storage had the highest plateau region capacity and overall capacity as well. For the RN resins, the carbonization temperature set at 1200° C. enabled the plateau region capacity and overall capacity to reach their peaks when the hard carbon material was applied to lithium-ion batteries.

A further observation of FIG. 4C reveals that, under the same carbonization temperature, the hard carbon material derived from the ON resin (Example 2) exhibited the highest plateau region capacity and overall capacity when applied to lithium-ion batteries. In comparison, the hard carbon material derived from the ON′ resin (Example 8) had a plateau region capacity of 160 mAh/g and an overall capacity of 390 mAh/g, both were higher than those of the half cell of a lithium-ion battery containing the hard carbon material of Example 5, which was derived from the RN resin.

FIG. 4D compares the Li-ion storage performance using hard carbon materials synthesized from the RN resins with different cross-linking densities but calcined under the same carbonization temperature. Examples 9, 5, and 10 were derived from the RN′ resin, RN resin, and RN″ resin, respectively. The half cell containing the hard carbon material of Example 9 exhibited a plateau region capacity of 115 mAh/g and an overall capacity of 305 mAh/g, while the battery from Example 10 showed a plateau region capacity of 135 mAh/g and an overall capacity of 355 mAh/g.

These results indicate that, with increasing the cross-linking density of the RN resin, the hard carbon materials, which were prepared under the same temperature, can achieve higher plateau capacities and overall capacities for lithium-ion batteries. Therefore, in order to attain the desired battery performance, it is feasible to alter the cross-linking density of phenolic-formaldehyde resins by adjusting the amount of cross-linking reagents used. Combined with an appropriate carbonization temperature, this approach enables the fabrication of expected hard carbon materials, and enhances the plateau region and overall capacities in the lithium-ion batteries.

Further, observations were made on the variation in the sloping region capacity corresponding to these two phenolic-formaldehyde resins. As the carbonization temperature increases, the sloping region capacity shows a decreasing trend. It highly corresponds to the decrease in d₀₀₂, the increase in Lₐ and L_{c}, and the reduction in I_{D}/I_{G} ratio, and is consistent with the aforementioned XRD and Raman results.

The correlation between the closed pore volume (corresponding to the amount of the closed pores) and the plateau region capacity of Li-ion storage within hard carbon materials for the negative electrode active materials of lithium-ion batteries was also analyzed. As shown in FIG. 4E, the coefficient of determination (R²) between the closed pore volume and the plateau region capacity of Li-ion storage was 0.88, showing a linear correlation with small deviations. This highly linear correlation suggests that the presence of the plateau region capacity was highly correlated with the closed pore volume in the microstructure of the hard carbon material. As the closed pore volume of the hard carbon material increases, the plateau region capacity of Li-ion storage is enhanced. A comprehensive investigation into the correlation of CLD of the phenolic-formaldehyde resin, closed pore volume, and plateau region capacity and overall capacity reveals that optimizing the thermal treatment, i.e., adjusting the carbonization temperature depending on the selected phenolic-formaldehyde resin and its CLD, can effectively regulate the closed pore volume of the hard carbon material, thereby maximizing the amount of the closed pores. Accordingly, the optimized hard carbon material enhances the plateau region capacity and thereby increases the overall capacity to their peaks when applied as a negative electrode active material in the lithium-ion battery.

A further detailed investigation on the Li-ion storage capacity of the cell assembled by using the hard carbon material of Example 2 revealed that the plateau region capacity (255 mAh/g) accounted for almost 50% of the overall capacity (550 mAh/g). The improved cell also had a better initial coulombic efficiency. This also indicates that maximizing the closed pore amount in the hard carbon material can be achieved by controlling the cross-linking density of the phenolic-formaldehyde resin and the carbonization temperature within appropriate ranges, thereby improving the performance of the lithium-ion battery.

### CC-CV

Hard carbon material of Example 4 and commercial hard carbon (HCN2L) were adopted as examples. Both of them were used as the negative electrode active materials of Li-ion batteries and assembled into the half cells, so as to compare the capacity difference exhibited by the different hard carbon materials applied in the lithium-ion batteries.

The half cell was lithiated at a constant current of 50 mA/g to 0.001 V, followed by a constant voltage hold until the current dropped below 5 mA/g, and then de-lithiated at a constant current of 50 mA/g within the operating voltage window from 0.001 V to 1.5 V (vs. Li⁺/Li). The results are shown in FIG. 4F.

As shown in FIG. 4F, the half cell assembled from the hard carbon material of Example 4 as the negative electrode active material of lithium-ion batteries exhibited mAh/g of plateau region capacity and 270 mAh/g of sloping region capacity, i.e., an overall capacity of 420 mAh/g. In contrast, no plateau region could be observed from the charge/discharge curve of the half cell assembled from the commercial hard carbon, and the overall capacity of Li-ion storage was quite lower than that of Example 4.

Based on the above comparison results, it confirms again that the closed pore formation and the regulation of the closed pore volume in the hard carbon material can be achieved by tuning the phenolic-formaldehyde resin and the carbonization temperature. This approach facilitates an increase of the plateau region capacity of hard carbon materials for the negative electrode active materials of lithium-ion batteries, thereby enhancing their overall capacity.

### Rate Performance

Hard carbon material of Example 2, commercial hard carbon, and graphite were used as the negative electrode active materials of lithium-ion batteries, and assembled into the half cells of lithium-ion batteries as samples for testing. The rate performance was carried out on a battery test system (model: CT3002AU, brand: Landt) with a current density from 50 mA/g to 2 A/g.

As shown in FIG. 4G, with increasing the current density, the half cell assembled using the hard carbon material of Example 2 typically exhibited a higher specific capacity compared to the commercial hard carbon (HCN2L) and graphite (MG11). When the current density returns to 50 mA/g, the half cell assembled from Example 2 exhibited the specific capacity comparable to the initial capacity, indicating excellent capacity retention.

In addition, a comparison of the rate performance between the hard carbon material of Example 2 and the commercial hard carbon reveals that the battery comprising Example 2 maintained a higher specific capacity at various current densities. This demonstrates that the closed pores in the hard carbon material can be maximized by tuning the cross-linking density of the phenolic-formaldehyde resin and its corresponding carbonization temperature, thereby exhibiting an excellent rate performance when applied to the lithium-ion batteries.

### Long-Cycle Performance

Hard carbon material of Example 2 as a negative electrode active material was assembled into a half cell of a lithium-ion battery as a testing sample. The long-cycle performance was carried out on the same foresaid battery test system with a current density from 50 mA/g to 2 A/g.

As shown in FIG. 4H, the half cell of a lithium-ion battery assembled from Example 2 retained 96.2% of its specific capacity after 50 cycles at a current density of 50 mA/g, highlighting its excellent reversible capacity in the low-potential plateau region and outstanding coulombic efficiency. Also, as shown in FIG. 4I, the half cell of a lithium-ion battery assembled from Example 2 still retained 62.9% of its specific capacity and outstanding coulombic efficiency after 4000 cycles at a current density of 2 A/g.

These results demonstrate that the hard carbon material can be applied to the lithium-ion batteries to exhibit outstanding long-cycle performance, effectively addressing the limitation of conventional silicon-based negative electrode materials, where significant capacity fading after repeated charge and discharge cycles hinders their practical application in full cells.

For a further investigation of practical application, LiFePO₄ was used as the positive electrode active material and the hard carbon material of Example 2 (E2) was used as the negative electrode active material with an N/P ratio of 1.1:1 to assemble a full cell, i.e., E2/LiFePO₄. The electrochemical measurement of the full cell was conducted at a current rate ranging from 0.2 C to 1 C. and within an operating voltage window ranging from 2 V to 4 V.

As shown in FIG. 4J, the full cell assembled with the hard carbon material of Example 2 exhibited a capacity of 138 mAh/g at a current rate of 0.2 C and a capacity of 120 mAh/g at a current rate of 10 C, demonstrating the promising future of the practical application in lithium-ion batteries.

[symbol]

Sodium-Ion Battery

[symbol]

In addition to the performance evaluation in lithium-ion batteries, the optimized hard carbon material of the instant disclosure can be applied to the sodium-ion batteries (SIBs) as the negative electrode active materials, thereby improving the plateau region capacity and overall capacity.

To evaluate the performance to SIB, the hard carbon material of Example 2 was used as an example and prepared into a carbon-coated electrode by the method as stated above. After that, the carbon-coated electrode was assembled into the half cell of a sodium-ion battery by a similar method as stated in the half cells of LIBs The main differences between LIB and SIB were that the electrolyte used in the SIB consisted of 1 M sodium hexafluorophosphate (NaPF₆) in a mixed solvent of EC, EMC, and DMC (1:1:1 by volume).

### GCD

The half cell of a sodium-ion battery assembled by the previous method was adopted as a sample to conduct the GCD cycle testing. A half cell was measured by using the abovementioned electrochemical analyzer at room temperature and a current density of 50 mA/g (0.15C) within an operating voltage window ranging from 0.001 V to 1.5 V (vs. Na⁺/Na).

As shown in FIG. 4K, the half cell prepared by using the hard carbon material of Example 2 exhibited a plateau region capacity of 225 mAh/g and an overall capacity of 344 mAh/g, in which the plateau region capacity accounted for more than 50% of overall capacity. The results demonstrate that the optimized hard carbon material is also suitable for the negative electrode of sodium-ion batteries and exhibits the beneficial effects in enhancing the plateau region capacity and overall capacity.

In conclusion, by employing the Novolak-typed phenolic-formaldehyde resin, it is feasible to control the recondensation reaction and design the cross-linking density of the phenolic-formaldehyde resin within a desired range. Also, an appropriate carbonization temperature can be set according to the cross-linking density of the phenolic-formaldehyde resin to ensure a favorable carbonization reaction, such that the desired closed pore structures are formed in the hard carbon material and the closed pore volume is enhanced. In addition, the correlation between the closed pore amount in the hard carbon material and the plateau region capacity can be found from the above experiment, indicating that the formation and maximization of the closed pore structure in the hard carbon material can be successfully achieved by the foresaid approaches. Therefore, such hard carbon materials having closed pores can be applied to various energy storage batteries, including lithium-ion and sodium-ion batteries, to exhibit the optimized charge and discharge performance, thereby enhancing their plateau region capacity and overall capacity as well.

What is claimed is:

1. A method of preparing a hard carbon material having closed pores, comprising steps of:
reacting a phenolic compound with an aldehyde compound in the presence of an acid catalyst to prepare a phenolic-formaldehyde oligomer;
subjecting the phenolic-formaldehyde oligomer, a cross-linking reagent, and a protection reagent to a recondensation reaction, so as to obtain a phenolic-formaldehyde resin having a cross-linking density ranging from 0.5 to 0.999, inclusive; and
thermally treating the phenolic-formaldehyde resin at a carbonization temperature ranging from 700° C. to 1500° C., inclusive, to obtain a hard carbon material,
wherein the hard carbon material comprises multiple closed pores, and the hard carbon material has a closed pore volume ranging from 0.1 cm³/g to 0.4 cm³/g, inclusive.

2. The method as claimed in claim 1, wherein the phenolic-formaldehyde resin is a Novolak-typed phenolic-formaldehyde resin, and an ortho ratio of the phenolic-formaldehyde resin ranges from 10% to 50%, inclusive.

3. The method as claimed in claim 1, wherein an ortho ratio of the phenolic-formaldehyde oligomer ranges from 50% to 100%, inclusive.

4. The method as claimed in claim 1, wherein the closed pore volume of the hard carbon material ranges from 0.18 cm³/g to 0.38 cm³/g, inclusive.

5. The method as claimed in claim 1, wherein the step of subjecting the phenolic-formaldehyde oligomer, the cross-linking reagent, and the protection reagent to the recondensation reaction comprises:
mixing the phenolic-formaldehyde oligomer, the cross-linking reagent, and the protection reagent in a solvent to obtain a mixture;
heating the mixture at a temperature of 100° C. to 180° C., inclusive, by microwave to obtain a suspension solution containing the phenolic-formaldehyde resin; and
filtering and drying the suspension solution, so as to collect the phenolic-formaldehyde resin from the suspension solution,
wherein, based on 100 parts by weight of the phenolic-formaldehyde oligomer, an amount of the cross-linking reagent ranges from 5 parts by weight to 100 parts by weight, inclusive, an amount of the protection reagent ranges from 1 part by weight to 10 parts by weight, inclusive, the cross-linking reagent is selected from the group consisting of: hexamethylenetetramine, formaldehyde acetal, furfural, furfural alcohol and trimethylol phosphine oxide, and the protection reagent is selected from the group consisting of: polyvinyl alcohol, methyl cellulose and polyoxyethylene polyoxypropylene.

6. The method as claimed in claim 1, wherein a cross-linking density of the phenolic-formaldehyde resin ranges from 0.5 to 0.9, inclusive, and the carbonization temperature ranges from 700° C. to 1400° C., inclusive.

7. The method as claimed in claim 6, wherein a cross-linking density of the phenolic-formaldehyde resin ranges from 0.60 to 0.85, inclusive, and the carbonization temperature ranges from 750° C. to 1150° C., inclusive.

8. The method as claimed in claim 6, wherein an ortho ratio of the phenolic-formaldehyde resin ranges from 30% to 50%, inclusive.

9. The method as claimed in claim 6, wherein the phenolic compound is phenol, the aldehyde compound is formaldehyde, the acid catalyst is zinc diacetate, and an amount of the zinc diacetate relative to an amount of the phenol ranges from 0.5 wt % to 10 wt %, inclusive.

10. The method as claimed in claim 6, wherein an ortho ratio of the phenolic-formaldehyde oligomer ranges from 70% to 100%, inclusive.

11. The method as claimed in claim 1, wherein a cross-linking density of the phenolic-formaldehyde resin ranges from 0.9 to 0.999, inclusive, and the carbonization temperature ranges from 850° C. to 1450° C., inclusive.

12. The method as claimed in claim 11, wherein the cross-linking density of the phenolic-formaldehyde resin ranges from 0.95 to 0.995, inclusive, and the carbonization temperature ranges from 850° C. to 1350° C., inclusive.

13. The method as claimed in claim 11, wherein an ortho ratio of the phenolic-formaldehyde resin ranges from 10% to 30%, inclusive.

14. The method as claimed in claim 11, wherein the phenolic compound is phenol, the aldehyde compound is formaldehyde, the acid catalyst is oxalic acid, and an amount of the oxalic acid relative to an amount of phenol ranges from 0.5 wt % to 10 wt %, inclusive.

15. The method as claimed in claim 11, wherein an ortho ratio of the phenolic-formaldehyde oligomer ranges from 50% to 70%, inclusive.

16. A method of enhancing a plateau region capacity of an energy storage device, comprising coating a negative electrode active material of the energy storage device onto a metal foil, wherein the negative electrode active material comprises a hard carbon material having closed pores, which is prepared by the method as claimed in claim 1, and the hard carbon material has a closed pore volume ranging from 0.1 cm³/g to 0.4 cm³/g, inclusive.

17. A method of preparing an energy storage device, comprising steps of:
coating a negative electrode slurry onto a negative electrode current collector and drying to obtain a negative electrode;
coating a positive electrode slurry onto a positive electrode current collector and drying to obtain a positive electrode; and
placing the negative electrode, the positive electrode, and a separator film into a case and filling an electrolyte solution into the case to prepare the energy storage device;
wherein the negative electrode slurry comprises a negative electrode active material, and the negative electrode active material comprises a hard carbon material having closed pores prepared by the method as claimed in claim 1.

18. The method as claimed in claim 17, wherein the electrolyte solution comprises a lithium salt solution or a sodium salt solution.

19. The method as claimed in claim 17, wherein the closed pore volume of the hard carbon material ranges from 0.18 cm³/g to 0.38 cm³/g, inclusive.
